(19) United States
(12) Patent Application Publication
(10) Pub. No.: US 2012/0303725 A1
(43) Pub. Date: Nov. 29, 2012

(54) Message Distribution System and Message Distribution Method

(75) Inventors: Tatsuya Sato, Fujisawa (JP); Tomohiro Hanai, Yokohama (JP); Tsunehiko Baba, San Jose, CA (US)

(73) Assignee: Hitachi Ltd, Chiyoda-ku Tokyo (JP)

(21) Appl. No.: 13/389,876

(22) PCT Filed: Mar. 4, 2010
(86) PCT No.: PCT/JP2010/053559

§ 371 Date: Feb. 10, 2012

(30) Foreign Application Priority Data
Feb. 18, 2010 (JP) 2010 033063

(51) Int. Cl. G06F 15/16

(52) U.S. Cl. 709/206

(57) ABSTRACT

The message delivery system has a first and a second computer and a storage device. The first computer receives messages sent from a sender, delivers the messages to at least a part of receiver computers and gets states of message delivery to these receiver computers. Based on the message delivery states, a check is made as to whether there are any slow receiver computers that have the message delivery thereto delayed. When there are slow receiver computers, a request is made to switch a message delivery control over the detected slow receiver computers from the first computer to the second computer. Then the second computer takes over the message delivery control over the slow receiver computers and resumes delivering the messages to the slow receiver computers.

### INCORPORATION BY REFERENCE

This application claims the priority benefit of Japanese Patent Application No. 2010-033063, filed on Feb. 18, 2010, the entire descriptions of which are incorporated herein by reference.

### TECHNICAL FIELD

The present invention relates to a method and a system for delivering messages via networks and more particularly to a method and a computer system for delivering messages from a sender computer through networks to a plurality of receiver computers.

### BACKGROUND ART

As the volume of information demanded by users and the number of users have been increasing in recent years, there are growing calls for information systems to deliver a large volume of data to a plurality of destinations. In information systems forming infrastructures of our society, as in a financial field, fast and reliable (equivalent to no data loss) data delivery is needed.

A system configuration commonly used to realize such information systems that meet these requirements employs a plurality of message delivery controlling servers (broker servers) in sending data (messages) to receiver servers (consumer servers). These information systems balance loads of message delivery among the plurality of broker servers to achieve an increased speed in sending messages to multiple consumer servers. A high reliability is achieved by having the broker servers duplicate messages to be delivered by making a copy of them and store them in non-volatile storage devices for persisting them.

Since a stable performance is demanded in terms of high speed capability, the broker servers must be able to be increased or decreased in number in accordance with the load to be processed and the number of consumer servers. Further, for flexible changes in the number of broker servers in use, it is also required that their building cost per one broker server be minimized. As described above, the stable performance and cost reduction require an efficient utilization of resources of the broker servers.

Technologies currently available to realize high speed and high reliability based on an efficient utilization of resources are disclosed in Patent Literature 1 and Patent Literature 2. Patent Literature 1 discloses a technology which uses a storage device dedicated to making messages durable or persistent to allow the message delivery process and the message persistence process to be carried out separately by different servers, thereby minimizing adverse effects that the message persistence process has on the message delivery performance. Further, bringing together storage devices that so far have been used in a plurality of broker servers into a single storage device offers an advantage of cost reduction. Patent literature 2 discloses a technology which connects broker servers in multiple layers and assigns only an upper layer of broker servers the message persistence process, thereby freeing lower-layer broker servers of the message persistence process and reducing the processing cost and storage capacity requirements.

### CITATION LIST

Patent Literature 1: JP-A-2008-527538
Patent Literature 2: US-A-2006-0248219

### SUMMARY OF INVENTION

### Technical Problem

In a system delivering messages to a plurality of consumer servers, a situation may occur in which the message delivery from broker servers is delayed depending on a state of processing on the part of consumer servers, resulting in some consumer servers also delayed to receive a message (such consumer servers, for which the message delivery is delayed, are called slow consumer servers for convenience). When a slow consumer server occurs, the demand for broker server resources increases, which in turn delays the message delivery to other normal consumer servers. To realize a stable high-speed message delivery to normal consumer servers, enough broker server resources need to be provided to deal with a possible increase in resource demand that would be caused by an occurrence of a slow consumer server. This, however, increases a broker server configuration cost.

When, for example, there is a slow consumer server, a broker server that is to deliver a message to that consumer server takes up more resources than otherwise to hold the message. Normally, the broker server stores messages in a buffer on memory. To ensure high level of reliability, the broker server holds the messages in its buffer until they are delivered to all consumer servers that are supposed to receive them. So, in the event of a message delivery delay even to one consumer server, the buffer is used to hold the undelivered message to that consumer server. Since the buffer capacity is limited, an increased number of undelivered messages will result in the messages overflowing the buffer.

As for the messages that overflowed the buffer, it is general practice to temporarily hold them in a storage device (or its equivalent). In holding the overflowing messages in a storage device, it is necessary to execute both a write process for storing the messages and a read process for using them. Since, in the event of a buffer overflow, resources are consumed for these processing, the amount of resources available for the message delivery process becomes smaller than during the normal delivery process, giving rise to a possibility of the message delivery performance being degraded.

In the event that a slow consumer server occurs in each of a plurality of broker servers, these broker servers have an increased processing load to deal with their own slow consumer servers. Another problem is that because each broker server holds the undelivered message in the buffer, there arises a possibility that the same message may be held redundantly in two or more broker servers. The waste of resources in holding the messages redundantly contributes to degrading the process performance of the information system as a whole, preventing the load balance among multiple broker servers from working effectively.

To cope with a possible buffer overflow in a plurality of broker servers, a storage device to persist the message may be provided to each broker server so that they can individually hold their own messages. This arrangement enables a message resending to be performed efficiently. However, to handle large quantities of and various kinds of messages requires storage devices with large capacity. These storage devices will not actually come into operation until a buffer overflow occurs. So, providing such a large-capacity storage device to every broker server is not desirable from a standpoint of cost reduction. Another approach of sharing one storage device among a plurality of broker servers to avoid the redundant storage of messages can minimize the cost. The storage device sharing, however, is accompanied by an additional process of exclusively writing into the storage, further increasing the load of the message persistence process.

With the conventional technologies described above, since locations where messages are stored to persist them in the event of a consumer server changing to a slow consumer server can be brought together into a single location, the cost of storage devices can be reduced. These conventional technologies, however, cannot address the problem that the presence of a slow consumer server delays the message delivery to other normal consumer servers, because an increase in the load of message delivery process caused by the occurrence of a slow consumer server affects all broker servers that are assigned to deliver messages to that slow consumer server.

In light of the above problem experienced with the conventional technologies, it is an object of this invention to realize a capability to stably deliver messages, even in the event of an emergence of a slow consumer server, to normal consumer servers.

### Solution to Problem

To achieve the above objective, one aspect of this invention provides a message delivery method in a message delivery system, wherein the message delivery system has a first and a second computer and a storage device accessible by the first and the second computer, receives messages from a sender and delivers them to a plurality of receiver computers. The message delivery method preferably involves receiving the messages sent from the sender by the first computer, delivering the messages to at least a part of the plurality of receiver computers, retrieving message delivery states and, based on the message delivery states, checking whether there is, among the receiver computers, any slow receiver computer for which the message delivery is delayed. If it is found that there is a slow receiver computer, a request is made to switch a message delivery control over the slow receiver computer from the first computer to the second computer. Then, the second computer takes over the message delivery control over the slow receiver computer and delivers the messages to the slow receiver computer.

More preferably, when a utilization rate of a buffer holding the messages in the second computer exceeds a predetermined threshold, at least a part of the messages is moved from the second computer into the storage device.

Still more preferably, the second computer checks whether, among the receiver computers under the message delivery control thereof, there are any normal receiver computers for which the message delivery is carried out normally. If it is found that a normal receiver computer exists, a request is made to switch a message delivery control over the normal receiver computer from the second computer to the first computer. Then, the first computer takes over the message delivery control over the normal receiver computer and delivers the messages to the normal receiver computer.

According to another aspect of this invention, there is provided a message delivery system which delivers messages to a plurality of receiver computers through a network. In a preferred aspect the message delivery system comprises a first computer and a second computer. The first computer has: a memory having a first buffer to hold the messages received, first delivery control information specifying a computer in control of a message delivery to each of the plurality of receiver computers, and first delivery state information showing states of message delivery to first receiver computers that, in the first delivery control information, are placed under a message delivery control of this first computer; a first message management means to receive the messages sent from a sender and hold them in the first buffer; a first delivery means to deliver the messages to the first receiver computers and update the first delivery state information; and a first switching means to check, based on the first delivery state information, whether among the first receiver computers there is a slow receiver computer for which the message delivery is delayed and, if it is found that there is the slow receiver computer, request a switch of a message delivery control over the slow receiver computer (to the second computer). The second computer has: a memory having a second buffer to hold the messages received, second delivery control information specifying a computer in control of a message delivery to each of the plurality of receiver computers, and second delivery state information showing states of message delivery to second receiver computers that, in the second delivery control information, are placed under a message delivery control of this second computer; a second message management means to receive the messages sent from the sender and hold them in the second buffer; and a second delivery means to update, in response to the request from the first computer, the second delivery control information to include the slow receiver computer among the second receiver computers, deliver the messages to the second receiver computers and update the second delivery state information.

The second message management means preferably monitors a utilization state of the second buffer and, when a buffer utilization rate exceeds a predetermined threshold, moves at least a part of the messages to the storage device.

More preferably, the second computer further has a second switching means which checks, based on the second delivery state information, whether there is a normal receiver computer for which the message delivery is carried out normally and, when it is found that there is a normal receiver computer, requests a switch of a message delivery control over the normal receiver computer to (the first computer). In response to the request from the second computer, the first delivery means updates the first delivery control information to include the normal receiver computer among the first receiver computers.

Still another aspect of this invention provides a message delivery computer used in the aforementioned message delivery system. The message delivery computer preferably comprises: a memory having a buffer to hold the messages, computer information showing whether a computer of interest is assigned to deliver messages to those slow receiver computers among a plurality of receiver computers for which the message delivery is delayed, a message delivery control information specifying a computer in control of a message delivery to each of the plurality of receiver computers, and information on a state of message delivery to the receiver computers which, in the message delivery control information, are put under the message delivery control of this message delivery computer; a message management means to receive the messages from outside and store them in the buffer; a delivery processing means to deliver, according to the message delivery control information, the messages received by the message management means to those receiver computers under the message delivery control of this message delivery computer and updates the message delivery state information; and a delivery control switching means which, when this message delivery computer is not assigned to deliver messages to the slow receiver computers, detects the slow receiver computers from among the receiver computers under the message delivery control of this message delivery computer according to the message delivery state information and requests a switch of a message delivery control over the detected slow receiver computers (to another message delivery computer), and which, when this message delivery computer is assigned to deliver messages to the slow receiver computers, detects normal receiver computers from among the receiver computers under the message delivery control of this message delivery computer according to the message delivery state information and requests a switch of a message delivery control over the detected normal receiver computers (to another message delivery computer).

### ADVANTAGEOUS EFFECTS OF INVENTION

Even in the event that some of consumer servers turn slow, this invention allows the resources of the broker servers to be efficiently used, realizing stable message delivery to the consumer servers.

Other objects, features and advantages of this invention will become apparent from the following description of embodiments of the invention.

### BRIEF DESCRIPTION OF DRAWINGS

FIG. 1 A schematic block diagram showing a hardware construction of a computer system in a first embodiment of this invention.

FIG. 2 A schematic block diagram showing a construction of a broker server mainly comprising software modules.

FIG. 3 A conceptual diagram showing a structure of a broker server table.

FIG. 4 A conceptual diagram showing a structure of a delivery control server table.

FIG. 5 A conceptual diagram showing a structure of a delivery state table.

FIG. 6 A conceptual diagram showing a structure of a decision threshold table.

FIG. 7 A sequence diagram showing a message delivery process during a normal state.

FIG. 8 A flow chart showing a sequence of steps executed by a message management unit in a message registration process.

FIG. 9 A flow chart showing a message delivery process performed by a delivery processing unit.

FIG. 10 A flow chart showing a sequence of steps executed by the delivery processing unit when it receives a message receiving acknowledgment from a consumer server.

FIG. 11 A flow chart showing a sequence of steps in a message deletion process executed by a normal delivery process broker server.

FIG. 12 A flow chart showing a sequence of steps in a message retrieval process executed by the message management unit.

FIG. 13 A sequence diagram showing a process of switching a message delivery control between the broker servers.

FIG. 14 A flow chart showing a sequence of steps in a slow consumer server detection process and a delivery control switching process executed by a normal delivery process broker server.

FIG. 15 A flow chart showing a sequence of steps in a delivery control freeing process executed by the delivery processing unit of the normal delivery process broker server.

FIG. 16 A flow chart showing a sequence of steps in a delivery control registration process executed by the delivery processing unit of a slow consumer server-dedicated broker server.

FIG. 17 A sequence diagram showing a delivery control switching process to switch to another broker server the control of message delivery to normal consumer servers.

FIG. 18 A flow chart showing a sequence of steps in a normal consumer server detection process and a delivery control switching process, executed by a delivery control switching unit of a slow consumer server-dedicated broker server.

FIG. 19 A flow chart showing a sequence of steps in a failover process.

FIG. 20 A conceptual diagram showing a decision threshold table in a second embodiment.

FIG. 21 A sequence diagram showing a delivery control switching process to switch to another broker server the control of message delivery to slow consumer servers, executed by a delivery control switching unit of a normal delivery process broker server.

FIG. 22 A flow chart showing a sequence of steps in a slow consumer server detection process and a delivery control switching process, executed by a delivery control switching unit of the normal delivery process broker server.

FIG. 23 A sequence diagram showing a delivery control switching process to switch to another broker server the control of message delivery to normal consumer servers.

FIG. 24 A flow chart showing a sequence of steps in a normal consumer server detection process and a delivery control switching process, performed by the delivery control switching unit.

FIG. 25 A flow chart showing a message delivery process performed by the delivery processing unit.

FIG. 26 A schematic block diagram showing a hardware construction of a computer system in a third embodiment.

FIG. 27 A conceptual diagram showing a decision threshold table.

FIG. 28 A sequence diagram showing a switching process to switch to another broker server the control of message delivery to slow consumer servers, a process of delivering messages to slow consumer servers, and a message deletion process.

FIG. 29 A flow chart showing a sequence of steps executed in a process of detecting a consumer server to be switched to another broker server and a delivery control switching process.

FIG. 30 A sequence diagram showing a process of switching back the message delivery control between broker servers.

FIG. 31 A flow chart showing a process of detecting a consumer server to be switched back to the former broker server and a delivery control switching process, executed by the delivery control switching unit.

### DESCRIPTION OF EMBODIMENTS

### First Embodiment

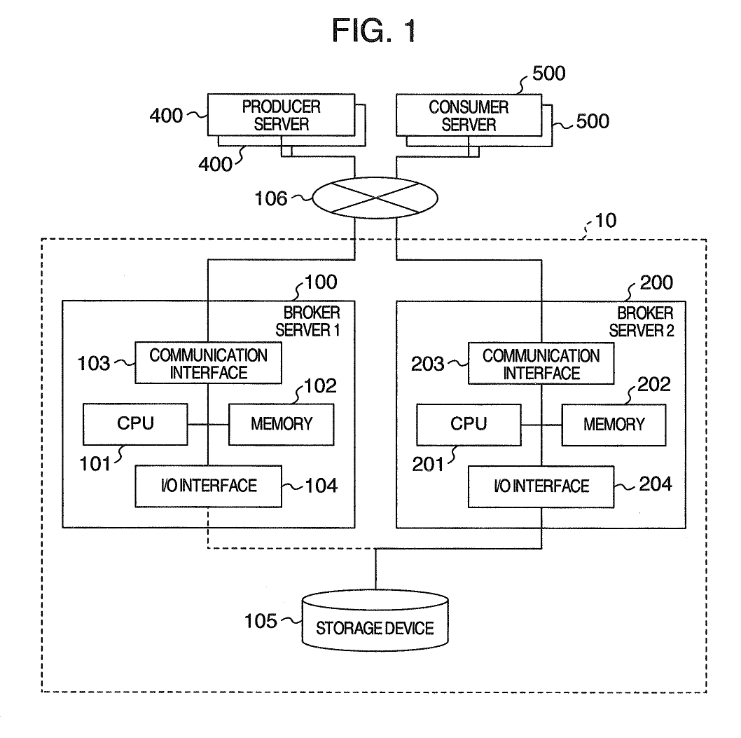

FIG. 1 is a schematic block diagram showing a hardware construction of a computer system as one embodiment of this invention.

In FIG. 1, a message delivery system 10 has two broker servers 100, 200 and a storage device 105 used by the broker servers. The message delivery system 10 (broker servers 100, 200) is connected through a network 106 to producer servers 400 as senders from which messages are delivered and a plurality of consumer servers 500 as receivers to which messages are delivered. The producer servers 400 and the consumer servers 500 are able to communicate with any of the broker servers 100, 200. Communication is also possible between the broker server 100 and the broker server 200 via the network 106. Although two producer servers 400 are shown here, any desired number of producer servers may be employed, e.g., one or three or more.

The broker server 100 comprises a CPU 101 to perform computations, a memory 102 in which to store programs to be executed by the CPU 101 and data used in a variety of processes, a communication interface 103 for communication with other servers via the network 106, and an I/O interface 104 through which to input and output data to and from the storage device 105. The broker server 200, as in the broker server 100, has a CPU 201, a memory 202, a communication interface 203 and an I/O interface 204. Messages received from the producer servers 400 and intended to be forwarded to the consumer servers 500 are stored in buffers on the memories 102, 202.

In this embodiment, the broker servers 100, 200 deliver messages received from the producer servers 400 to their allocated consumer servers 500. In the event that any of the consumer servers 500 covered by the broker server 100 turns slow in receiving messages, the function of delivering messages to that slow consumer server is switched over to the broker server 200. That is, the broker server 100 works as a broker server assigned to handle a message delivery to normal consumer servers (a normal delivery process broker server) and the broker server 200 as a broker server dedicated to message delivery to only slow consumer servers (a slow consumer server-dedicated broker server).

Normally, messages sent out from the producer servers 400 are received by the broker server 100. The broker server 100, upon receiving messages from the producer servers 400, duplicates the received messages and gives a copy to the broker server 200. The broker server 100 and the broker server 200 forward the messages received from the producer servers 400 to a plurality of consumer servers 500 allocated to them. The broker servers 100, 200 therefore normally function as a concurrently active dual system, delivering messages to the consumer servers 500 that have been allocated to them beforehand.

The broker server 100 and the broker server 200 periodically notify each other of their process states via a network for mutual monitoring (heartbeat monitoring) to detect a possible failure of each other. When one of the broker servers fails, the other takes over the message delivery process from the failed broker server to ensure that the message delivery can continue normally in the event of a failure (such an arrangement is called a high availability (HA) configuration). As described above, the messages are duplicated by the two broker servers and held there until the message delivery is completed, realizing a high level of reliability. Further, since there is a limit on the message duplicating capacity, the broker servers 100, 200 have a function of making messages durable by storing the messages in the storage device 105.

The normal delivery process broker server 100 has a function of detecting a delay in the message delivery to the consumer servers 500 allocated to it (a slow consumer server detection function). When it detects slow consumer servers, the normal delivery process broker server 100 switches the function of delivering messages destined for the slow consumer servers to the slow consumer server-dedicated broker server 200. Transferring the process of delivering messages bound for slow consumer servers from the normal delivery process broker server 100 to the slow consumer server-dedicated broker server 200, as situation demands, causes the task of message delivery to the slow consumer servers to be performed collectively only by that broker server 200.

The slow consumer server-dedicated broker server 200, on the other hand, has a function of detecting when the message delivery to any of the consumer servers 500 allocated to it turns normal (a normal consumer server detection function). As the process of message delivery to the slow consumer server is switched to the slow consumer server-dedicated broker server 200, the amount of resources used by the broker server 200 increases (a message delivery load is unevenly delivered). If left unaddressed, the increased resource consumption will have an adverse effect on the performance of the message delivery to the normal consumer servers covered by the broker server 200. So, when the amount of resources used by the slow consumer server-dedicated broker server 200 increases, the process of message delivery to those consumer servers 500 that the broker server 200 has detected as normal is switched over to the normal delivery process broker server 100 to solve the problem of unbalanced loads.

In this embodiment, the storage device 105 normally is connected to the I/O interface 204 of the slow consumer server-dedicated broker server 200 so that the broker server 200 can use it to make messages durable. In the event that the broker server 200 fails, the message delivery process is taken over by the broker server 100 and therefore the storage device 105 is connected to the I/O interface 104 of the broker server 100 so that the broker server 100 can use it for persisting messages.

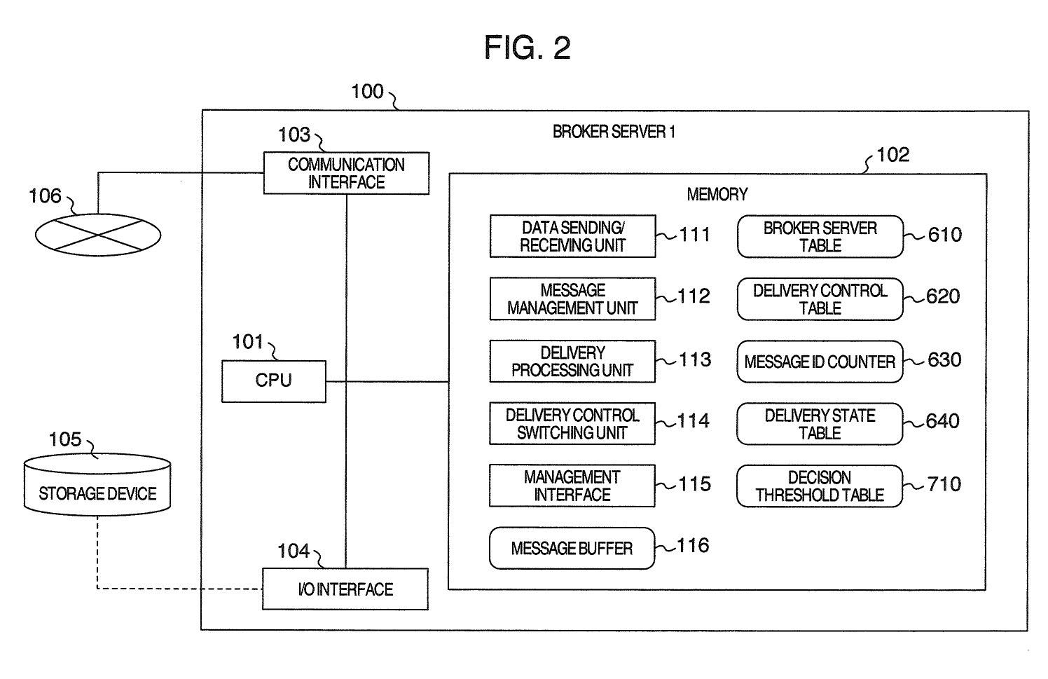

FIG. 2 is a schematic block diagram showing the construction of a broker server comprised mainly of software modules. While the broker server 100 is taken up as an example, the broker server 200 also is constructed in a similar way. So, unless otherwise specifically stated, the explanation of this example is also applicable to the broker server 200.

In this embodiment, the broker server 100 has a data sending/receiving unit 111, a message management unit 112, a delivery processing unit 113, a delivery control switching unit 114 and a management interface 115. These functional units are provided in the form of software modules and placed on the memory 102. These program modules are run by the CPU 101 to implement a variety of functions described below.

Arranged on the memory 102 are a message buffer 116 which temporarily stores messages dispatched from the producer servers 400 that are to be delivered to the consumer servers 500; a broker server table 610 to manage information on the broker servers; a delivery control table 620 to manage information on a relation between the consumer servers 500 and the broker servers in charge of message delivery to the consumer servers; a message ID counter 630 used to get message IDs that uniquely identify messages; a delivery state table 640 showing message delivery statuses for the consumer servers 500 allocated to each broker server; and a decision threshold table 710 showing a set of thresholds used to make a decision for a slow or normal consumer server detection and for starting the detection process. The broker server table 610, delivery control table 620, message ID counter 630, delivery state table 640 and decision threshold table 710 are used in the message delivery process and the process of selecting the broker server in charge of the message delivery.

In this embodiment, as a message ID attached to each message to be delivered, a serial number is used that increments by one in the order of dispatch from producer servers 400. For this purpose, the message ID counter 630 holds a count value that is incremented by one each time the broker server attaches a message ID to a message received from the producer servers. The message ID needs only to be an identifier capable of uniquely identifying a particular message and may be determined by any other means than the counter value employed in this embodiment. Information held in other tables will be detailed later.

The broker server 100 performs data communication with the other broker server 200, the producer servers 400 and the consumer servers 500 through the data sending/receiving unit 111. In the description of procedures that follows, the explanation of the process performed by the data sending/receiving unit 111 is omitted for the sake of simplicity. It should be understood, however, that communication with the outside world is made via the data sending/receiving unit 111.

The broker server 100 has a message management unit 112 and a delivery processing unit 113 to perform the message delivery process. The broker server 100 receives messages at the message management unit 112 from the producer servers 400. The message management unit 112 stores the received messages in the message buffer 116. The messages stored in the message buffer 116 are sent to the consumer servers 500 by the delivery processing unit 113. When, with this broker server working as a slow consumer server-dedicated broker server, the message buffer 116 seems likely to overflow, the message management unit 112 performs a message persistent process by moving a part of the messages held in the message buffer 116 to the storage device 105.

The delivery control switching unit 114 monitors the state of the broker server 100 to detect an occurrence of a slow consumer server and, when it detects one, changes the broker server that is tasked with delivering messages to the slow consumer server. The switch of the message delivery control between the broker server 100 and the broker server 200 is done by the switching unit 114 of the broker server 100 communicating with the delivery control switching unit of the broker server 200. In this embodiment, the switching unit 114 of the normal delivery process broker server 100 detects the occurrence of a slow consumer server and switches its message delivery control to the broker server 200 before the message buffer 116 overflows. So, the message overflow from the buffer can occur only in the broker server 200. The message persistence process using the storage device 105 therefore needs only to be performed by the broker server 200.

The management interface 115 has a function of setting parameters that constitute decision criteria used to start the delivery control switching process by the delivery control switching unit 114 and to determine a consumer server to be switched to another broker server. The management interface 115 desirably has a GUI (Graphical User Interface) capability but may be of CUI (Character User Interface). The management interface 115 may also be provided to only one of the broker servers, with its setting reflected on the other broker server through the communication between them.

As for the functional units 111-116 in each broker server, when they need to be distinguished between the broker server 100 and the broker server 200, subscripts “−1” and “−2” are attached at the end of each functional unit, such as a message management unit 112-1 and a delivery processing unit 113-1 for the broker server 100 and a message management unit 112-2 and a delivery processing unit 113-2 for the broker server 200.

The broker server table 610, the delivery control table 620, the message ID counter 630, the delivery state table 640 and the decision threshold table 710 are placed in the memories 102, 202 of the broker servers 100, 200. It is possible to provide a common memory area or storage device so that the two broker servers can share information in these tables.

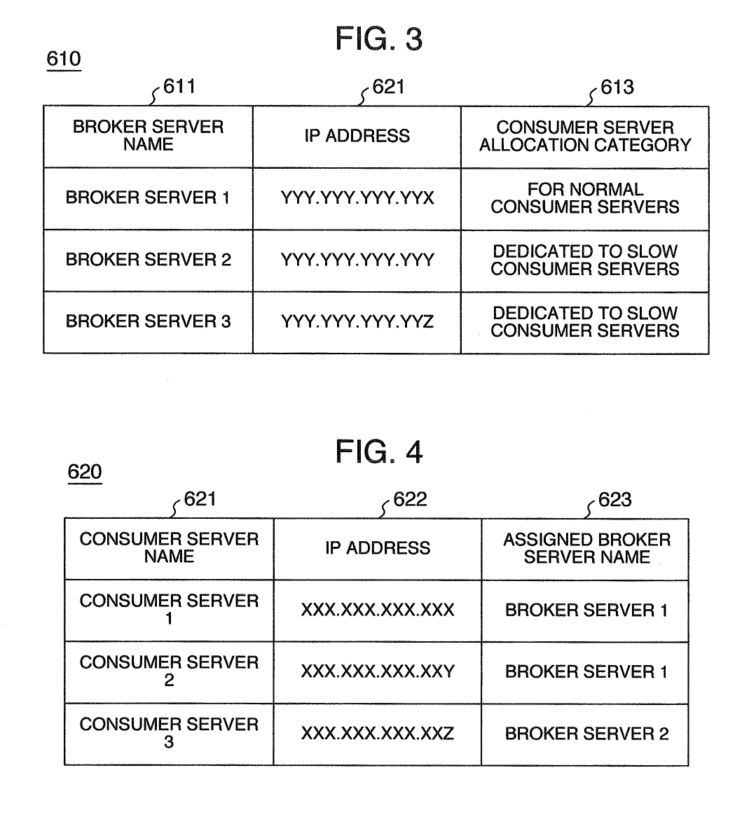

FIG. 3 is a conceptual diagram showing a structure of the broker server table. The broker server table 610 is used by any broker server to check information on other broker servers. The broker server 100 therefore establishes synchronization with the broker server 200 in terms of information set on the broker server table 610 to maintain consistency between the broker server tables held in the two broker servers. Such synchronization of information can be achieved by using known technologies and its explanation is omitted here. Rather than synchronizing the two broker servers, it is possible to provide a memory area that can be accessed by both of the broker servers 100, 200 so that they can share the broker server table 610.

The broker server table 610 includes a broker server name 611, an IP address 612 and a consumer server allocation category 613. The broker server name 611 represents server names given to the broker servers 100, 200 in the message delivery system 10. The IP address 612 represents IP addresses assigned to broker servers that are identified by the broker server names 611. The consumer server allocation category 613 represents the kind of consumer servers put under the message delivery control of the broker servers 100, 200. In this embodiment, there are two categories: “for normal consumer servers” and “dedicated to slow consumer servers.” The broker servers 100, 200 check their own consumer server allocation category to choose a proper process according to their assigned control. Further, by checking the consumer server allocation category of the other broker server, the first broker server can identify a broker server to which it is going to switch the message delivery control over the consumer servers. Although this embodiment uses IP addresses as the addresses of the broker servers 100, 200, any other information or identifiers may be employed as long as they can identify the address of a destination to which messages are delivered.

FIG. 4 is a conceptual diagram showing a structure of a delivery control table. The delivery control table 620 is managed and used by the broker servers 100, 200 to check the consumer servers 500 allocated to each of them. The delivery control table 620 may also be used when a message delivery request comes from other than the consumer servers 500 covered by the broker server 100 or 200 which then attempts to identify a broker server covering the requesting consumer server and redirect the request to the identified broker server.

The delivery control table 620 includes a consumer server name 621, an IP address 622 and a name of assigned broker server 623. The consumer server name 621 represents server names of the consumer servers 500 that the message delivery system 10 covers for their message delivery. The IP address 622 represents addresses of the consumer servers 500 identified by the consumer server names 621. The assigned broker server name 623 represents server names of the broker servers 100, 200 in charge of message delivery to each of the consumer servers 500. The assigned broker server name 623 corresponds to the broker server name 611 in the broker server table 610.

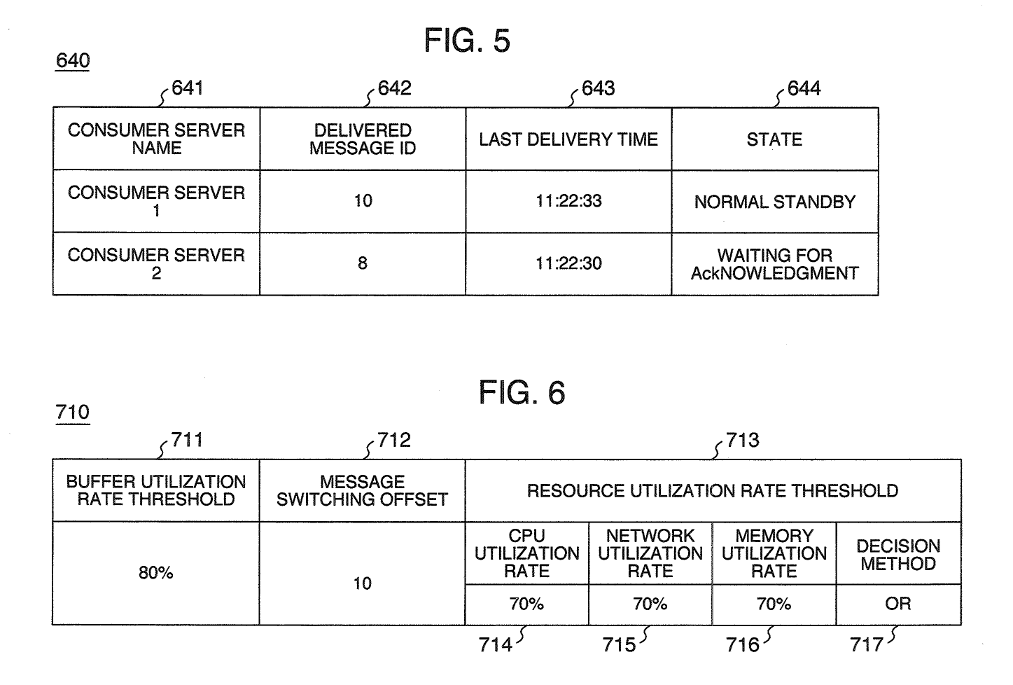

FIG. 5 is a conceptual diagram showing a structure of a delivery state table. The delivery state table 640 includes a consumer server name 641, a delivered message ID 642, a last delivery time 643 and a state 644 and is managed by each broker server, 100, 200.

The consumer server name 641 represents server a name of each consumer server 500 covered by the broker server 100 or 200 and corresponds to the consumer server name 621 in the delivery control table 620. The delivered message ID 642 represents a message ID of the last of the messages that have been delivered to the associated consumer server 500. The broker server 100, 200 increments the delivered message ID 642 each time it receives a message receiving acknowledgment from the consumer server 500.

Here, how the messages are delivered will be explained. In this embodiment, each of the consumer servers 500 receives all messages that have arrived at the broker server 100 in the same order of receiving. In the process of sending messages to the consumer servers 500, therefore, the broker server 100 or 200 sends the next message to each consumer server only after receiving a message receiving acknowledgment from it. This is just one example of message delivery scheme and any other method may be employed.

The last delivery time 643 represents a time when the broker server 100 or 200 sent a message to a consumer server the last time. Each time it sends a message, the broker server 100, 200 updates the last delivery time 643. The last delivery time 643 is used as a criterion for initiating a message resending to the consumer server 500. Other information may be used in place of the last delivery time as long as it can function as a criterion for the resending described later.

The state 644 represents information on the state of each consumer server 500. There are two states the consumer servers 500 can be in: “normal standby” and “waiting for acknowledgment (Ack)”. When the state 644 is the “normal standby”, the broker server 100, 200 sends the next message to the associated consumer server 500 and updates the state 644 to the “waiting for Ack”. When it receives a message receiving acknowledgment from the consumer server 500, the broker server 100, 200 updates the state 644 to the “normal standby”. When the state 644 is the “waiting for Ack”, the broker server 100, 200 performs resending of the message.

FIG. 6 is a conceptual diagram showing a structure of a decision threshold table. The decision threshold table 710 includes a buffer utilization rate threshold 711, a message switching offset 712 and a resource utilization rate threshold 713. The resource utilization rate threshold 713 has as sub-items a CPU utilization rate 714, a network utilization rate 715, a memory utilization rate 716 and a decision method 717.

The decision threshold table 710 is used by the broker server 100 in finding slow consumer server or by the broker server 200 in finding normal consumer servers. In this embodiment, the values in the decision threshold table 710 are entered by an operator through the management interface 115. They may be calculated according to a delay in the message delivery or predetermined values may be used.

The buffer utilization rate threshold 711 is a value of the message buffer utilization that constitutes a decision criterion for initiating the slow consumer server detection process by the broker server 100. The message switching offset 712 is a value that allows an ID value some margin when a decision is made about a progress in the message delivery to each consumer server 500 (slow or normal). This is used both for the slow consumer server decision by the broker server 100 and for the normal consumer server decision by the broker server 200.

The resource utilization rate threshold 713 constitutes a criterion for deciding whether it is necessary, as a result of a load increase in the broker server 200, to switch the message delivery process for the normal consumer servers from the broker server 200 to the broker server 100. When the resource utilization on the part of the broker server 200 exceeds the resource utilization rate threshold 713, the broker server 200 initiates the normal consumer server detection process. The decision method 717 has two possible states “AND” and “OR”, which are used by a logical operation in the decision making using the CPU utilization rate 714, the network utilization rate 715 and the memory utilization rate 716.

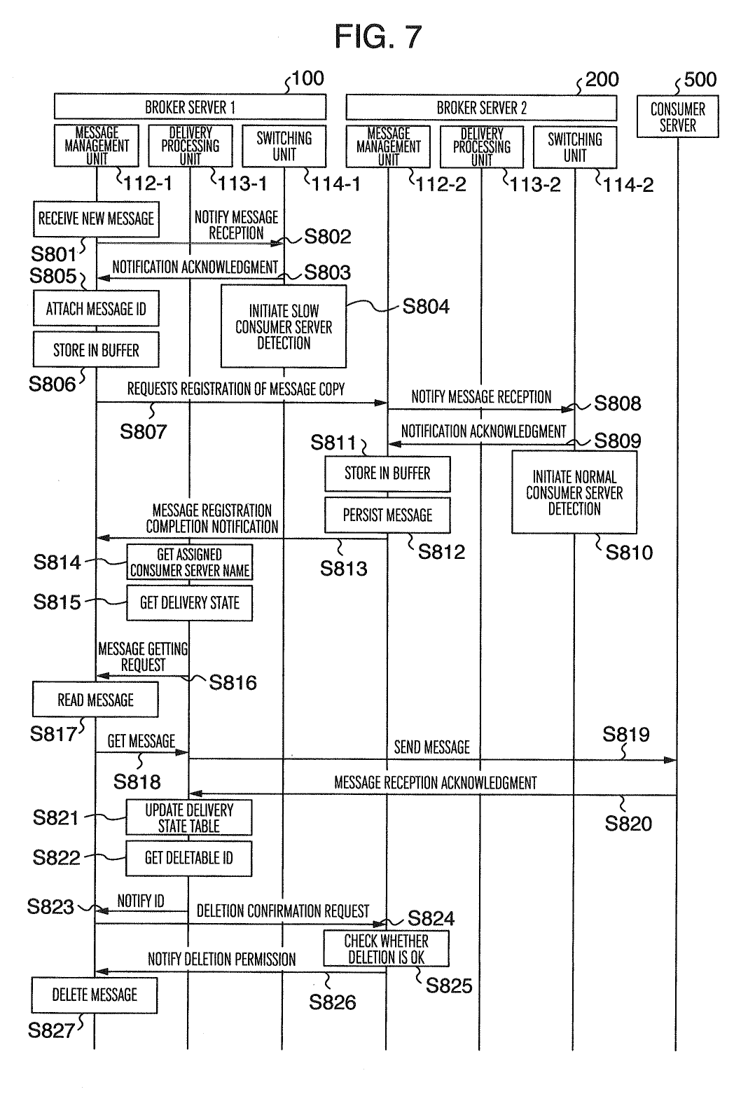

FIG. 7 is a sequence diagram showing the message delivery process in the normal state.

Steps S801-S813 represents a sequence of steps in the message registration process executed when the broker server 100 receives messages from a producer server 400.

The message management unit 112-1 of the broker server 100, upon receiving a new message from the producer server 400 (S801), notifies the delivery control switching unit 114-1 of a message receiving (S802). The switching unit 114-1, when it receives the message receiving notification, returns a receiving notification acknowledgment to the message management unit 112-1 (S803). Then the broker server 100 starts the slow consumer server detection process (S804).

After receiving the receiving notification acknowledgment from the switching unit 114-1, the message management unit 112-1 attaches a message ID to the received message (S805) and stores the message in the message buffer 116-1 (S806). Further, the message management unit 112-1 sends a copy of the received message to the message management unit 112-2 of the broker server 200 and requests it to register the copy. In this embodiment, the message is duplicated by the following process (S807).

On receiving the message copy registration request from the broker server 100, the message management unit 112-2 of the broker server 200 notifies the delivery control switching unit 114-2 of a message receiving (S808). The switching unit 114-2, when it receives the message receiving notification, returns a receiving notification acknowledgment to the message management unit 112-2 (S809) and starts the normal consumer server detection process (S810). Although different process names are given to the message copy registration requesting process at S807 and the new message receiving process at S801 for ease of explanation, they are realized by essentially the same processing as described later.

The message management unit 112-2, after receiving the receiving notification acknowledgment from the switching unit 114-2, stores the received message copy in the message buffer 116-2 (S811). At this time, in the broker server 200 tasked with holding messages whose delivery is delayed, a situation may arise where the message buffer 116-2 runs low on its capacity as the amount of messages held increases. In such a case, the message management unit 112-2 performs a message persistence process by writing those messages overflowing from the message buffer 116-2 into the storage device 105 (S812).

After this message holding process is finished, the message management unit 112-2 of the broker server 200 notifies the message management unit 112-1 of the broker server 100 that it has completed a message registration, before ending the message registration process (S813).

Steps S814-S827 are a sequence of steps that the broker server 100 performs during the process of delivering messages to the consumer server 500.

The delivery processing unit 113-1 of the broker server 100 references the delivery control table 620 to get information showing which consumer servers 500 are allocated to it (S814). The delivery processing unit 113-1 also checks the delivery state table 640 for delivery states of the consumer servers 500 it covers (S815). Based on the delivery states thus obtained, the delivery processing unit 113-1 specifies a message ID to the message management unit 112-1 and requests the unit to get the corresponding message to it (S816). The message management unit 112-1, upon receiving of the message retrieval request, reads a message with the specified message ID from the message buffer 116-1 and sends it to the delivery processing unit 113-1 (S818).

The delivery processing unit 113-1 sends the gotten message to the associated consumer server 500 (S819). When it receives a message receiving acknowledgment (Ack) from the consumer server 500 (S820), the delivery processing unit 113-1 updates the delivery state table 640 (S821). Further, the delivery processing unit 113-1 checks the delivery state table 640 to get a message ID of the message that can be erased at that time (S822) and notifies the message management unit 112-1 of the got, erasable message ID (S823).

If the message whose message ID was notified to the message management unit 112-1 remains in the message buffer 116-1, the message management unit 112-1 checks with the message management unit 112-2 of the broker server 200 whether it is possible to erase the message in order to keep the buffer from overflowing. It is noted that this embodiment assures high reliability by duplicating messages between the broker servers 100 and 200 and persisting messages in the broker server 200. Therefore, before deleting a message in the broker server 100, a check must be made to see if the message delivery is finished also in the broker server 200 or if the message persistence process is completed.

The message management unit 112-2 of the broker server 200, upon receiving a deletion confirmation request from the message management unit 112-1 of the broker server 100 (S824), checks whether the message delivery to all the consumer servers 500 covered by the broker server 200 is completed or the message has been guaranteed in the storage device 105, and determines whether or not the message can be deleted (S825). If it is confirmed that the message is deletable, the message management unit 112-2 notifies a message deletion permission to the message management unit 112-1 of the broker server 100 (S826). On receiving of the message deletion permission, the message management unit 112-1 erases the message from the message buffer 116-1 (S827).

The steps S814-S827 of the process described above are also executed, though not shown, on the side of the broker server 200, sending a message to the consumer servers 500 allocated to the broker server 200. In the message deletion process on the part of the broker server 200, the steps of checking with the other broker server for a message deletion, i.e., the steps S824-S826, are not necessary. The process of deleting a message which has not been persisted will be initiated when the message delivery to all consumer servers covered by the broker server 200 is finished or when the deletion confirmation request from the broker server 100 is received, whichever is later.

Although the broker server has been described to perform the message delivery process for one of the consumer servers allocated to it, the message delivery process from steps S814 to step S827 is actually executed repetitively for all consumer servers that it covers. Further, while the message registration process and the message delivery process have been described to be performed in one sequence of processes, they may be performed asynchronously. Similarly, although the message deletion process (S822-S827) has been described to be performed as part of the message delivery process, the process of S814-S821 and the process of S822-S827 may be separated and executed independently of each other.

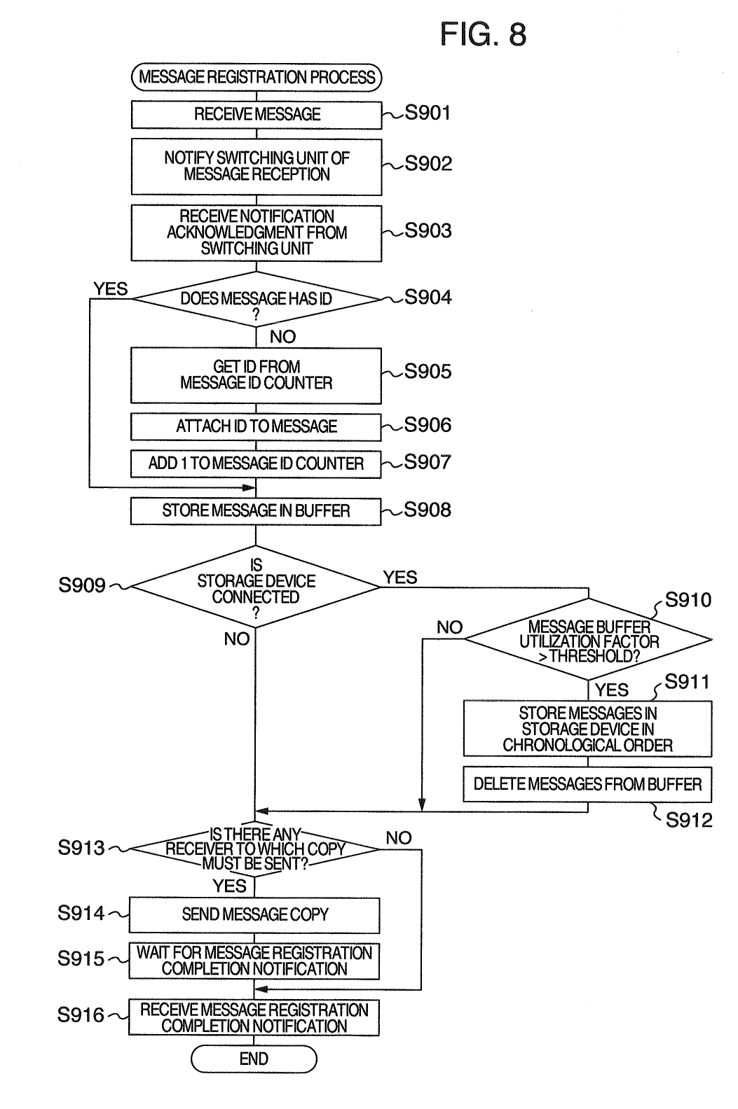

FIG. 8 is a flow chart showing a sequence of steps executed by the message management unit in the message registration process. The process shown in FIG. 8 corresponds to steps S801-S813 in the sequence diagram of FIG. 7.

When it receives a message dispatched from a producer server 400 or a message registration request, together with a message copy, from another broker server (S901), the message management unit 112 informs the delivery control switching unit 114 that it has received a message and waits for a receiving notification acknowledgment (S902).

Upon receiving the receiving notification acknowledgment from the switching unit 114 (S903), the message management unit 112 checks whether the received message is attached with a message ID. If the received message is a new one from the producer server 400, it has no message ID. So, the result of the decision made by the message management unit 112 at step S904 is “no message ID attached”. If, on the other hand, the message management unit 112 receives a message copy from another broker server, as in the case of the broker server 200 that works as a slow consumer server-dedicated broker server during the normal process, the message received is already attached with a message ID and thus the result of decision is “a message ID attached” (S904).

If at step S904 it is decided that the message received has “no message ID attached”, the message management unit 112 gets a current message ID from the message ID counter 630 (S905) and attaches it to the message (S906). Then, the message management unit 112 increments the value of the message ID counter 630 by 1 so that the incremented value can be attached as a message ID to the next new message it will receive (S907).

After the message ID has been attached to the message at steps S904-S907, or if step S904 decides that the message has “a message ID attached”, the message management unit 112 stores the received message in the message buffer 116 (S908). Next, the message management unit 112 checks whether this broker server is connected with the storage device 105. During the normal process the storage device 105 is connected to the broker server 200 that works as a slow consumer server-dedicated broker server, not to the broker server 100 that works as a normal delivery process broker server. So, the result of decision made by the message management unit 112-1 of the broker server 100 during the normal process is “no” and the processing moves to step S913. On the other hand, the result of decision made by the message management unit 112-2 of the broker server 200 during the normal process is “yes” (S909).

If the storage device 105 is connected to this broker server, the message management unit 112 calculates the utilization rate of the message buffer 116 based on a ratio between the volume of messages in the buffer and the maximum capacity of the buffer and checks if the utilization rate thus calculated exceeds a threshold (S910).

If it is decided that the utilization rate of the message buffer 116 is in excess of the threshold, the message management unit 112 reads out the messages held in the message buffer 116 in a chronological order of their message IDs and stores them in the storage device 105 (S911). The messages stored in the storage device are deleted from the message buffer 116 (S912). In this embodiment the message transfer to the storage device 105 at steps S911, S912 is done in a predetermined amount at a time. It is also possible to move all the messages held in the message buffer 116 at one time or to set variable the amount of messages to be moved.

At step S913 the message management unit 112 checks whether there are any broker servers to which it has to send a copy of the received message. The message management unit 112 refers to the broker server table 610 to check the consumer server allocation category 613 associated with the broker server name 611 of this broker server. If the category 613 is “for normal consumer servers”, the message management unit 112 is required to send a copy of the message to other “slow consumer server-dedicated” broker server. During the normal process, the broker server 100 must send a message copy to the broker server 200 whereas the broker server 200 does not need to send the message copy to another broker server. So, the result of the decision made by the message management unit 112-1 is “yes” and that of the message management unit 112-2 is “no”. In a system where additional broker servers are provided, if there are any broker servers that do not deliver messages during the normal process as in a third embodiment or if different messages are destined for different consumer servers and there are any broker servers that are not assigned to any of the consumer servers as receiver to which messages are delivered, there is no need to send a message copy to such broker servers. In that case, the message management unit 112 refers to the delivery control table 620 to determine to which broker server the message copy must be sent.

If the result of the decision made at step S913 is “yes”, the message management unit 112 sends a message copy to the message management unit 112 of the broker server that needs it (S914). Then, it waits for a message registration completion notification from the broker server to which the message copy was sent, until the notification is received (S915).

If the message management unit 112 decides at step S913 that the sending of a message copy is not necessary or when it has received at step S915 a message registration completion notification from the broker server to which the message copy was sent, the message management unit 112 forwards the message registration completion notification to the producer server or the broker server, from which the message received at S901 originated, before exiting the message registration process (S916).

Although the message registration process and the process of notifying message registration completion to the producer server have been described to be performed in one sequence of steps, other methods may be used. For example, the registration completion notification process may be performed asynchronously independent of the registration process and a plurality of registration completion notifications may be sent collectively.

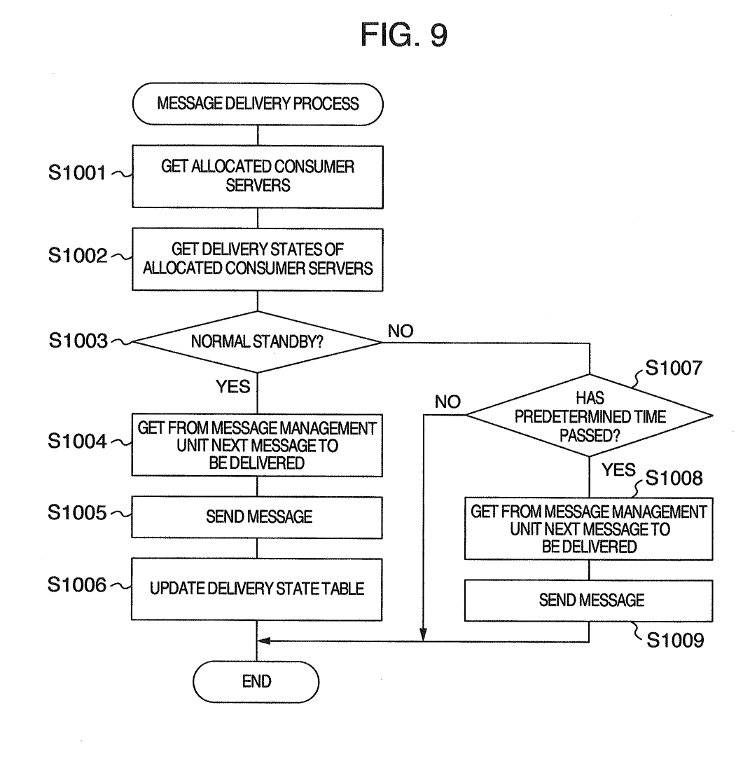

FIG. 9 is a flow chart showing a message delivery process performed by the delivery processing unit. The process shown in FIG. 9 corresponds to steps S814-S819 in the sequence diagram of FIG. 7.

The delivery processing unit 113 gets from the delivery control table 620 a consumer server name of one consumer server 500 that it is assigned to handle (S1001). Next, it gets from the delivery state table 640 a delivery state of the consumer server 500 corresponding to the gotten consumer server name (S1002). Based on the delivery state of the consumer server 500, the delivery processing unit 113 checks whether the information set in the state 644 is “normal standby” or “waiting for acknowledgement (Ack)” (S1003).

If step S1003 decides that the consumer server 500 is in the “normal standby” state, the delivery processing unit 113 specifies a message ID of a message next to the one identified by the delivered message ID 642, (delivered message ID+1), and requests the message management unit to send the corresponding message to it (S1004). Upon receiving the message from the message management unit, the delivery processing unit 113 forwards the message to the consumer server 500 (S1005). Then, the delivery processing unit 113 changes the state 644 in the table 640 of the consumer server 500, to which it has just sent the message, to “waiting for Ack” and the last delivery time 643 to the present time or the time of the message sending (S1006).

On the other hand, if step S1003 decides that the consumer server 500 is in the “waiting for Ack” state, the delivery processing unit 113 calculates a difference between the present time and the time set in the last delivery time 643 and checks if the “waiting for Ack” state continues for more than a predetermined duration (S1007). If it is determined that the period of the “waiting for Ack” state does not exceed the predetermined duration, the delivery processing unit 113 simply exits the process of message delivery to the consumer server without performing further processing.

If at step S1007 it is decided that the “waiting for Ack” state has continued for more than the predetermined duration, the delivery processing unit 113 again gets the next message to the one identified by the delivered message ID 642 (S1008) and sends the message (S1009). The delivery processing unit 113 performs the above message delivery procedure successively for all consumer servers allocated to this broker server. The message delivery to individual consumer servers may be done parallelly as by multithreading. The above message delivery process is performed in the same way by all broker servers.

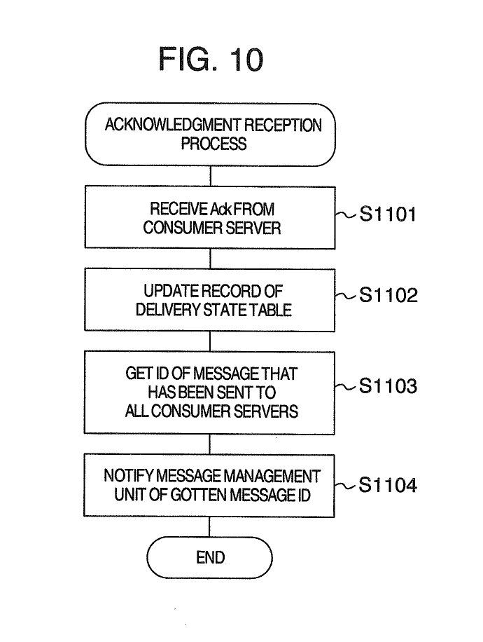

FIG. 10 is a flow chart showing a sequence of steps that the delivery processing unit executes when it receives a message receiving acknowledgment from a consumer server. The process shown in FIG. 10 corresponds to steps S820-S823.

On receiving a message receiving acknowledgment from a consumer server 500 (S1101), the delivery processing unit 113 increments the value of the delivered message ID 642 in the delivery state table 640 for the consumer server 500, from which the unit 113 has received the message receiving acknowledgment, and changes the state 644 to the “normal standby” (S1102). Next, the delivery processing unit 113 gets from the delivery state table 640 a message ID of the message that has been delivered to all consumer servers 500, i.e., a minimum value of the delivered message ID 642 among all consumer servers (S1103), and notifies it as a deletable message ID to the message management unit (S1104).

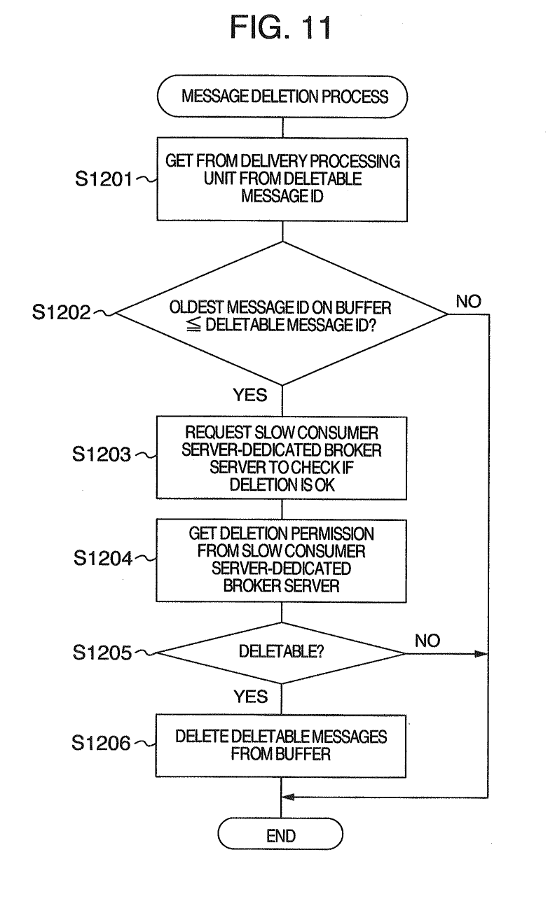

FIG. 11 is a flow chart showing a sequence of steps that the message management unit of the normal delivery process broker server executes during the message deletion process. The process shown in FIG. 11 corresponds to the steps S823-S827 in the sequence diagram of FIG. 7.

When it receives from the delivery processing unit 113-1 the message ID representing the deletable message that has been delivered to all consumer servers (S1201), the message management unit 112-1 gets a message ID attached to the oldest message held in the message buffer 116-1 and compares it to the message ID received from the delivery processing unit 113-1 to see if there are any deletable messages in the buffer. If the message ID of the oldest message in the message buffer 116-1 is equal to or less than the message ID received from the delivery processing unit 113-1, there are messages in the message buffer 116-1 that can be deleted (S1202).

If step S1202 decides that there is a deletable message in the message buffer 116-1, the message management unit 112-1 notifies a deletable message ID to the message management unit 112-2 of the slow consumer server-dedicated broker server 200 and requests it to check whether the message in question can be erased (S1203). Then, upon receiving the check result from the message management unit 112-2 of the broker server 200 (S1204), the message management unit 112-1 looks it up to determine whether the message in question can be deleted (S1205).

If the result of the decision made at step S1205 is “yes”, the message management unit 112-1 deletes from the message buffer 116-1 the message with the message ID received at step S1201 and older messages (with IDs smaller than the received message ID) (S1206). If the result of the decision at S1202 or S1205 is “no”, the message management unit 112-1 exits the message deletion process without erasing a message.

The message management unit 112-2 of the broker server 200, that was asked at step S1203 to check for a possible message deletion, checks if the message with the received message ID and older messages do not exist in the message buffer 116-2 (these messages have already been moved to the storage device 105 for persisting them) or if these messages have been delivered to all consumer servers 500 covered by the broker server 200. Then the broker server 200 returns its check result. Another method for message deletion check and response that may be carried out by the message management unit 112-2 involves first moving the deletable messages, if they exist in the message buffer 116-2, to the storage device 105 for persisting them and then returning the message deletion permission. This method allows for a more efficient use of the message buffer 116-1 of the normal delivery process broker server 100.

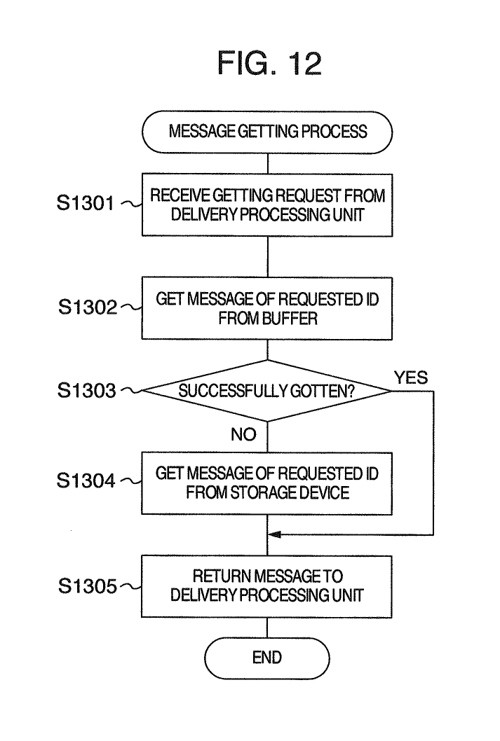

FIG. 12 is a flow chart showing a sequence of steps that the message management unit performs during the message retrieval process.

Upon receiving the message retrieval request, along with the specified message ID, from the delivery processing unit 113 (S1301), the message management unit 112 reads out a message with the specified message ID from the message buffer 116 (S1302). In the case of a normal delivery process broker server, if there are any consumer servers 500 to which the message has not yet been delivered, that message is always held in the message buffer 116. But in the case of a slow consumer server-dedicated broker server, the message of interest may have already been moved from the message buffer 116 to the storage device 105. So, the message management unit 112 at step S1302 checks whether the message has been successfully read out (S1303).

If step S1303 decides that the message retrieval from the message buffer 116 has failed, the message management unit 112 gets a message with the specified message ID from the storage device 105 (S1304).

The message management unit 112 then returns to the delivery processing unit 113 the message read out from the storage device at step S1304 or, if the result of the S1303 decision is affirmative, a message read out from the message buffer 116 (S1305).

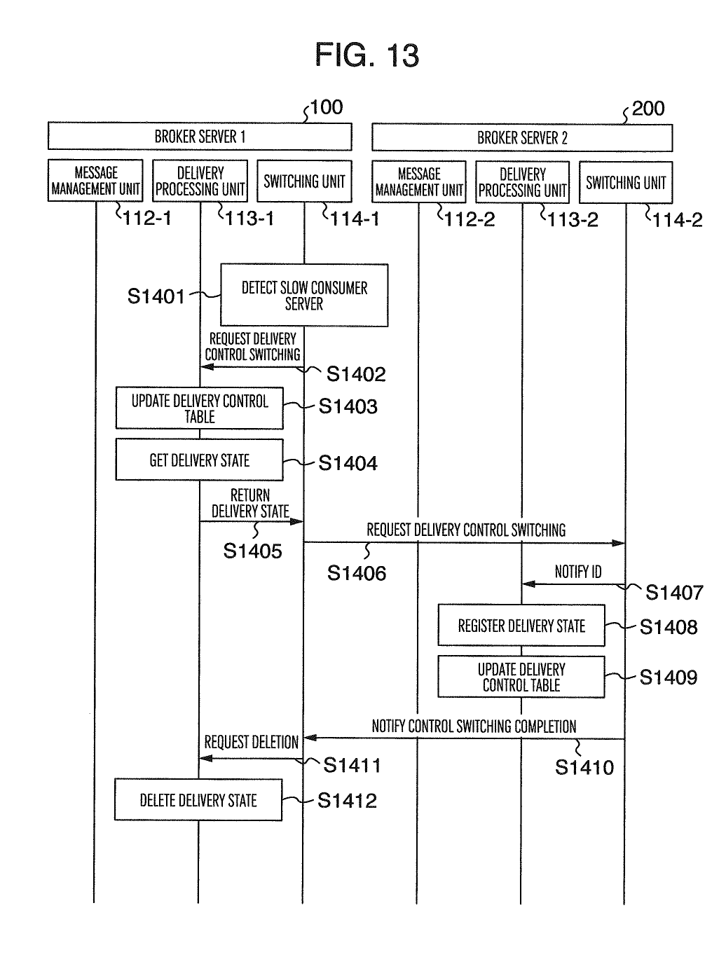

FIG. 13 shows a sequence of steps in a delivery control switching process which, when a slow consumer server occurs among the consumer servers covered by a normal delivery process broker server (broker server 100), is carried out to switch the slow consumer server to another broker server.

The delivery control switching process is initiated when the delivery control switching unit 114-1 of the broker server 100 detects at least one slow consumer server among the consumer servers 500 covered by the broker server 100 (S1401). Detailed explanation of the slow consumer server detection process will be given later. The switching unit 114-1, upon detecting the occurrence of a slow consumer server, requests the delivery processing unit 113-1 to switch the delivery control over the detected slow consumer server to another broker server by specifying that slow consumer server (S1402).

When it receives the delivery control switching request, the delivery processing unit 113-1 updates the delivery control table 620 by changing the assigned broker server name 623 associated with the specified consumer server name 621 from the name of the broker server 100 to the name of the broker server 200 (S1403). Then, the delivery processing unit 113-1 gets the delivery state of the consumer server in question from the delivery state table 640 (S1404) and returns it to the switching unit 114-1 (S1405).

With the delivery control table 620 updated, the slow consumer server moves out of the delivery control of the broker server 100, with the result that the delivery processing unit 113-1 stops the message delivery to the consumer server in question. If, during the delivery control switching process, an acknowledgment or a resending request is sent over from that slow consumer server to the broker server 100, the acknowledgment or the resending request are redirected to the newly assigned broker server 200 or ignored until the assigned broker server 200 takes control of the slow consumer server.

Next, the switching unit 114-1 requests the switching unit 114-2 of the broker server 200 to switch the delivery control over the slow consumer server to another broker server. At this time, the switching unit 114-1 sends the delivery state of the consumer server in question received from the delivery processing unit 113-1 to the switching unit 114-2 along with the switching request (S1406).

The switching unit 114-2 of the broker server 200, upon receiving the switching request, requests the delivery processing unit 113-2 to switch the delivery control over the slow consumer server to another broker server (S1407).

When it receives the switching request from the switching unit 114-2, the delivery processing unit 113-2 registers in the delivery state table 640 the delivery state sent over from the broker server 100 (S1408) to update the delivery control table 620 (S1409). Now that the above steps are executed, the broker server 200 takes control of the message delivery to the slow consumer server and starts sending messages to that consumer server.

After this, the switching unit 114-2 informs the switching unit 114-1 of the broker server 100 that the delivery control switching is complete (S1410).

On receiving the notification of the delivery control switching completion, the switching unit 114-1 of the broker server 100 requests the delivery processing unit 113-1 to erase the delivery information on the consumer server in question (S1411). The delivery processing unit 113-1 now erases the delivery state of the slow consumer server from the delivery state table 640 (S1412).

With the above steps taken, the switching process is exited. Although in this embodiment the message delivery process is resumed without informing the consumer server, which has been reallocated to another broker server, that its message delivery control has been switched to another broker server, it is also possible, at the time of delivery control switching, to explicitly notify the consumer server that the broker server tasked with sending messages to it has been changed.

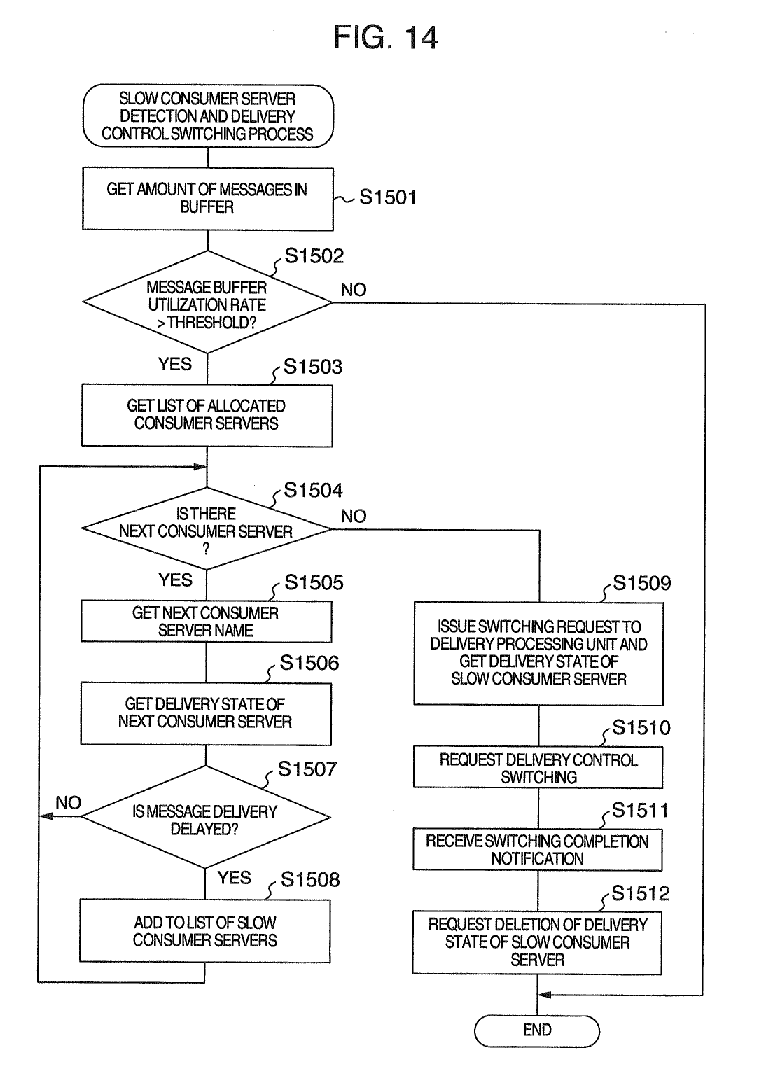

FIG. 14 is a flow chart showing a sequence of steps that the delivery control switching unit of the normal delivery process broker server executes during the slow consumer server detection process and the delivery control switching process. In the figure, steps S1501-S1508 constitute the slow consumer server detection process and steps S1509-S1512 the switching process. The slow consumer server detection process and the switching process correspond to step S1401 and steps S1402-S1412, respectively.

In the slow consumer server detection and delivery control switching processes, the delivery control switching unit 114-1 first gets the amount of messages held in the message buffer 116-1 (S1501). It then calculates a ratio between the gotten amount of messages and the size of the message buffer 116-1 to obtain a utilization rate of the message buffer 116-1 and decides whether the calculated utilization rate is in excess of a buffer utilization rate threshold 711 set in the decision threshold table 710. If the utilization rate of the message buffer 116-1 exceeds the threshold, indicating a likelihood of the buffer overflowing, the slow consumer server detection process is performed in the subsequent processing (S1502).

If the utilization rate of the message buffer 116-1 is less than the buffer utilization rate threshold 711, there is no possibility of the buffer overflowing. So, the switching unit 114-1 exits the detection and switching process without doing anything. If the utilization rate of the message buffer 116-1 exceeds the buffer utilization rate threshold 711, the switching unit 114-1 gets from the delivery control table 620 a list of all the consumer servers 500 that are under the message delivery control of the broker server 100 (S1503). Then, the switching unit 114-1 checks if, in the gotten list of the consumer servers covered by the broker server 100, there remains any consumer server that has yet to be processed or checked (S1504).

In this embodiment, whether there is any delay in the message delivery is determined based on the state of message delivery to the consumer servers 500. More precisely, a consumer server 500 is determined to be a slow consumer server when a relatively large number of messages supposed to have been delivered to the consumer server remain undelivered. This decision is made as follows. If the delivery control switching unit 114-1 finds any unprocessed or unchecked consumer server 500 on the list, it gets a name of the next consumer server (S1505) and, from the delivery state table 640, obtains a state of message delivery to that consumer server 500 (S1506).

The delivery control switching unit 114-1 gets the delivered message ID 642 from the delivery state obtained at step S1506 and compares it with a delay decision criterion ID to see if there is any delay in the message delivery process. The delay decision criterion ID used here is a value in a message switching offset 712 of the decision threshold table 710 added to the message ID value of the oldest of the messages held in the message buffer 116-1. If the value of the delivered message ID 642 is equal to or less than the delay decision criterion ID, it is decided that the number of accumulation messages that have not yet been delivered is relatively large and that the message delivery to that consumer server is delayed. If no delay is found in the message delivery, the processing returns to step S1504 (S1507).

If at step S1507 it is decided that the message delivery process is delayed, the switching unit 114-1 adds the consumer server 500 being checked to a list of slow consumer servers and returns to step S1504 (S1508).

If step S1504 determines that all consumer servers 500 on the list allocated to the broker server 100 have undergone the detection process, the switching unit 114-1 switches to the delivery processing unit 113-1 the list of slow consumer servers detected by the detection process and a request to switch the message delivery control over the slow consumer servers to another broker server. In response to the delivery control switching request, the delivery processing unit 113-1 gets the delivery states corresponding to the slow consumer servers on the list and returns them to the switching unit 114-1. Now, the switching unit 114-1 obtains the delivery states of the slow consumer servers (S1509).

Next, the delivery control switching unit 114-1 sends to the delivery control switching unit 114-2 of the broker server 200 a delivery control switching request including the delivery states of the slow consumer servers and waits for the delivery control switching to be completed (S1510). The switching unit 114-1, when it receives a switching completion notification from the switching unit 114-2 (S1511), requests the delivery processing unit 113-1 to delete the delivery states of the slow consumer servers from the delivery state table 640. The delivery processing unit 113-1 deletes the associated information from the delivery state table 640 (S1512).

Although this embodiment detects a slow consumer server according to the number of delayed messages held in the message buffer 116 and the delivery state of the consumer server, this detection may be done based on other criteria. For example, the slow consumer server may be detected according to the total size of delayed messages, the state of networks, response times or other resource utilization rate, or a combination of these.

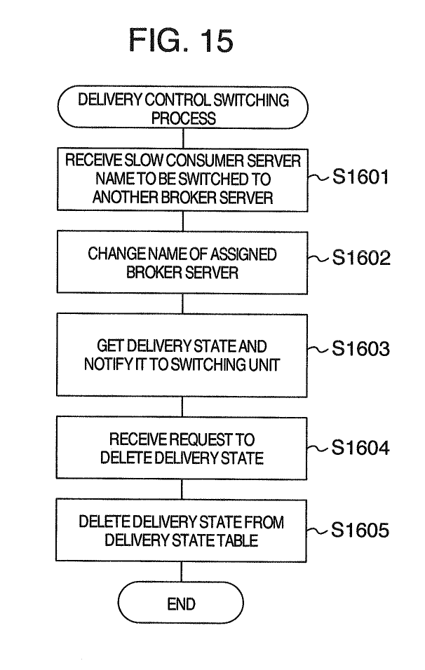

FIG. 15 is a flow chart showing a sequence of steps in a delivery control freeing process that the delivery processing unit of the normal delivery process broker server performs when a delivery control is switched. The procedure shown in FIG. 15 corresponds to steps S1403-S1404 and step S1412 in the sequence diagram of FIG. 13.

When it receives from the delivery control switching unit 114-1 the request to switch the message delivery control over the slow consumer servers to another broker server (S1601), the delivery processing unit 113-1 changes the assigned broker server names 623 corresponding to the server names 621 of the slow consumer servers—which were received along with the switching request—to the name of a delivery control switching to a broker server (in this case, the broker server 200) to remove these slow consumer servers from the control of this broker server (S1602). Then, the delivery processing unit 113-1 gets the delivery states of the slow consumer servers from the delivery state table 640 and takes them over to the switching unit 114-1 (S1603).

With the delivery control switching process by the broker server 200 completed and the delivery state deletion request from the switching unit 114-1 received (S1604), the delivery processing unit 113-1 deletes the delivery states of the slow consumer servers from the delivery state table 640 (S1605).

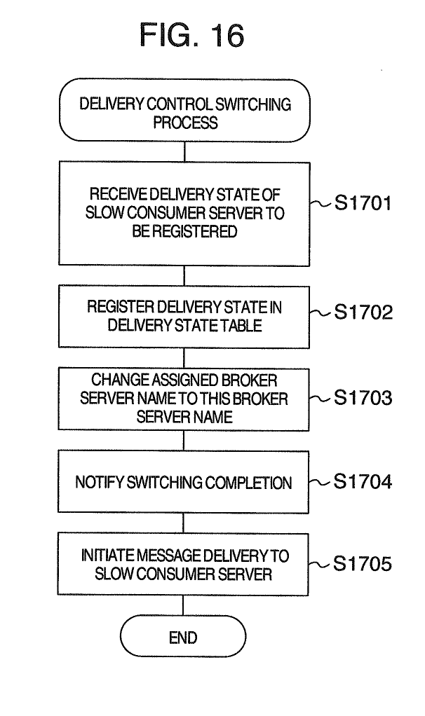

FIG. 16 is a flow chart showing a sequence of steps in a delivery control registration process executed by the delivery processing unit of the slow consumer server-dedicated broker server. The steps shown in FIG. 16 correspond to the steps S1408-S1409 in the sequence diagram of FIG. 13.

On receiving from the delivery control switching unit 114-2 the request to switch the delivery control over the slow consumer servers to another broker server, along with the delivery states of the slow consumer servers (S1701), the delivery processing unit 113-2 registers the received delivery states of the slow consumer servers in the delivery state table 640 (S1702). Then it changes the assigned broker server names 623 corresponding to the server names 621 of the slow consumer servers in the delivery control table 620 to this broker server name (the name of the broker server 200 in this case) and adds the slow consumer servers to the receivers these consumer server cover (S1703). The delivery processing unit 113-2 then notifies the switching unit 114-2 that the delivery control switching is complete (S1704). Now, the message delivery to these slow consumer servers is started (S1705).

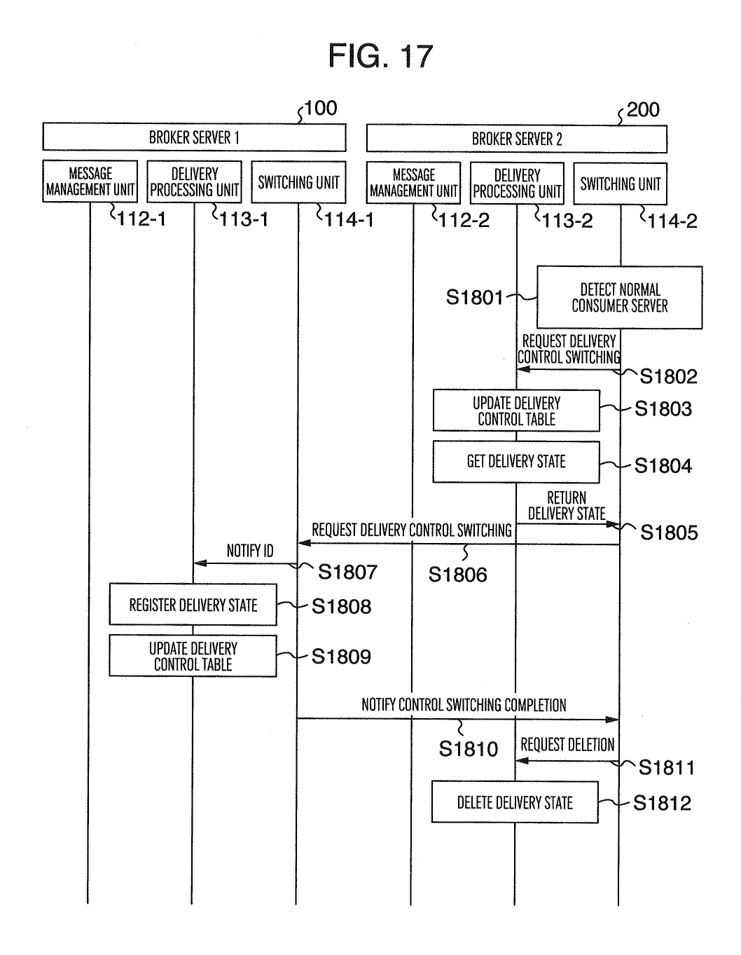

FIG. 17 is a sequence diagram showing a delivery control switching process to switch to another broker server the control of message delivery to normal consumer servers, performed when the load on the slow consumer server-dedicated broker server increases.

The process shown in FIG. 17 is initiated by the delivery control switching unit 114-2 when it detects, among the consumer servers 500 covered by the broker server 200, a normal consumer server ready to be reallocated to the normal delivery process broker server as a result of an increase in the load of the broker server 200. The normal consumer server detection process will be detailed later (S1801). The switching unit 114-2, when it detects a normal consumer server, requests the delivery processing unit 113-2 to switch the delivery control over the detected normal consumer server to another broker server by specifying the normal consumer server (S1802). In the following steps, as with the steps S1403-S1406 in the slow consumer servers' delivery control switching process, the delivery processing unit 113-2 updates the delivery control table 620 (S1803), gets the delivery states of the consumer servers to be reallocated to another broker server (S1804) and returns them to the switching unit 114-2 (S1805). The switching unit 114-2 sends a delivery control switching request along with the received delivery states to the switching unit 114-1 of the broker server 100 (S1806).

On receiving the switching request, the delivery control switching unit 114-1 of the broker server 100 requests the delivery processing unit 113-1 to perform the delivery control switching (S1807). Then, as with the steps S1408-S1410, the delivery processing unit 113-1 registers the received delivery states in the delivery state table 640 (S1808) and updates the delivery control table 620 (S1809). The switching unit 114-1 then returns a switching completion notification to the broker server 200 (S1810).

Then in the broker server 200, as with the steps S1411-S1412, the switching unit 114-2 requests the delivery processing unit 113-2 to delete the delivery states (S1811). In response to this, the delivery processing unit 113-2 deletes the delivery states of the associated consumer servers from the delivery state table 640 (S1812).

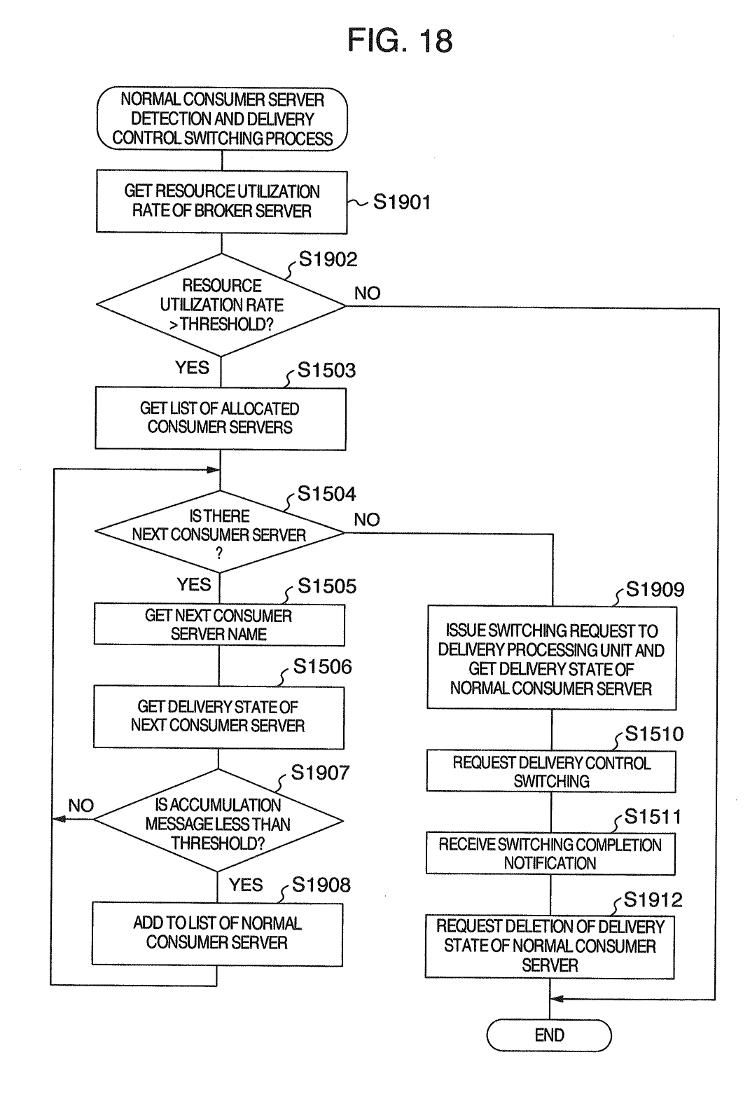

FIG. 18 is a flow chart showing a sequence of steps that the delivery control switching unit of the slow consumer server-dedicated broker server performs in the normal consumer server detection process and the delivery control switching process.

As the broker server tasked with delivering messages to the slow consumer servers is changed from the normal delivery process broker server 100 to the slow consumer server-dedicated broker server 200, the number of consumer servers covered by the broker server 200 increases, which in turn increases the amount of resources used by the broker server 200. The increased resource utilization volume will cause degradations in the message delivery performance of the broker server 200. This problem is dealt with as follows in this embodiment. When the volume of resources used by the broker server 200 exceeds a predetermined level, the control of message delivery to the normal consumer servers covered by the broker server 200 is switched from the broker server 200 to the normal delivery process broker server 100 to prevent an uneven balance of the message delivery load.

In the normal consumer server detection and delivery control switching processes, the delivery control switching unit 114-2 calculates a resource utilization rate of the broker server 200 (S1901). The switching unit 114-2 compares the calculated resource utilization rate with the threshold set in the resource utilization rate threshold 713 of the decision threshold table 710 to see if the resource utilization rate is in excess of the resource utilization rate threshold 713. If the result of this decision is “no”, the switching unit 114-2 exits the processing without starting the delivery control switching process (S1902).

If at S1902 it is found that the calculated resource utilization rate is in excess of the resource utilization rate threshold 713, the normal consumer server detection process (S1903-S1908) is initiated. The subsequent processing of the normal consumer server detection and delivery control switching process is almost similar to that of the slow consumer server detection process shown in FIG. 14 (S1503-S1512). Therefore, those steps in FIG. 18 that are identical to the corresponding ones shown in FIG. 14 are assigned the same reference numbers used in FIG. 14. In the following, mainly those parts of processing that differ from FIG. 14 will be described.

In the normal consumer server detection process, if, of the consumer servers on the list covered by the slow consumer server-dedicated broker server, there is a consumer server which, according to the delivery states obtained at steps S1505 and S1506, is found to have fewer delayed messages than a predetermined number, that consumer server is determined to be a normal consumer server. More specifically, the delivered message ID 642 obtained as the delivery state is compared with the normal consumer server criterion ID. If this comparison finds that the delivered message ID 642 is equal to or later than the normal consumer server criterion ID, the consumer server of interest is determined as a normal consumer server. The normal consumer server criterion ID used in this embodiment is a value of the message switching offset 712 in the decision threshold table 710 subtracted from the message ID of the latest of the messages held in the message buffer 116-2. If the comparison decides that the consumer server of interest is not normal, the processing returns to S1504 (S1907).

If at step S1907 a consumer server being checked is decided to be normal, the delivery control switching unit 114-2 adds the consumer server of interest to the normal consumer server list before returning to S1504 (S1908).

After step S1504 decides that all consumer servers 500 on the list covered by the slow consumer server-dedicated broker server have been checked, the switching unit 114-2 gets the delivery states of the normal consumer servers as in step S1509 (S1909) and, at steps S1510 and S1511, sends a delivery control switching request to and receives a switching completion notification from the broker server 100. Then, the switching unit 114-2 requests the delivery processing unit 113-2 to delete the delivery states of these normal consumer servers from the delivery state table 640. The delivery processing unit 113-2 then eliminates the corresponding information from the delivery state table 640 (S1912).

Although this embodiment employs the same message switching offset in calculating both the delay decision criterion ID used at step S1507 and the normal consumer server criterion ID used at step S1907, these criterion IDs may be calculated using different offset values.

In the delivery control switching process shown in FIG. 17, the delivery control freeing process performed by the delivery processing unit 113-2 of the broker server 200 and the delivery control registration process performed by the delivery processing unit 113-1 of the broker server 100 are carried out according to the flow charts of FIG. 15 and FIG. 16, respectively. It should be noted, however, that in this delivery control switching process, the roles of the broker server 100 and the broker server 200 are reverse to those shown in FIG. 14.

In this embodiment, the detection of slow, as well as normal, consumer servers is done based on the states of the broker server that performs the detection process and of the consumer servers to which the broker server delivers messages. From the standpoint of optimizing the overall processes performed by the message delivery system as a whole, the state of a delivery control switching to a broker server may also be used as a decision criterion in addition to the state of this broker server. Further, although the decision on the states of consumer servers is based on the delivery states managed on the broker server side, it is also possible to use states managed on the consumer server side, such as resource utilization rates.

In the embodiment described so far, although the decision on whether or not to reallocate consumer servers to another broker server is made by this broker server currently in charge of message delivery to these consumer servers, any server can make this decision. For example, a broker server that is going to take over the message delivery control may perform the slow consumer server detection and request the other broker server to switch the message delivery control when the first broker server has enough idle capacity in its resource utilization rate. Further, although the message delivery control has been described to be switched between the two broker servers in cooperation with each other, the delivery control switching may be done by any other server. For example, a management server that monitors the states of the broker servers may be provided, with its message delivery system monitoring unit, such as a delivery state monitoring program, switching the message delivery control between the broker servers. In that case, the management server collects from the broker servers their message delivery states, the number and amount of delayed messages in their buffers, or their message delivery loads. Based on the information thus collected, the management server detects slow or normal consumer servers in a way similar to that described in the above embodiment. When slow or normal consumer servers are detected, the management server determines a broker server to be assigned to deliver messages to these consumer servers and switches the message delivery control to the newly assigned broker server.

Furthermore, although the delivery sever switching has been described to be performed for slow consumer servers and for normal consumer servers separately, the broker servers may exchange their consumer servers with each other, for example, by having one of the broker servers take over its consumer servers that were detected as slow consumer servers to the other broker server and take over the normal consumer servers from the other broker server.

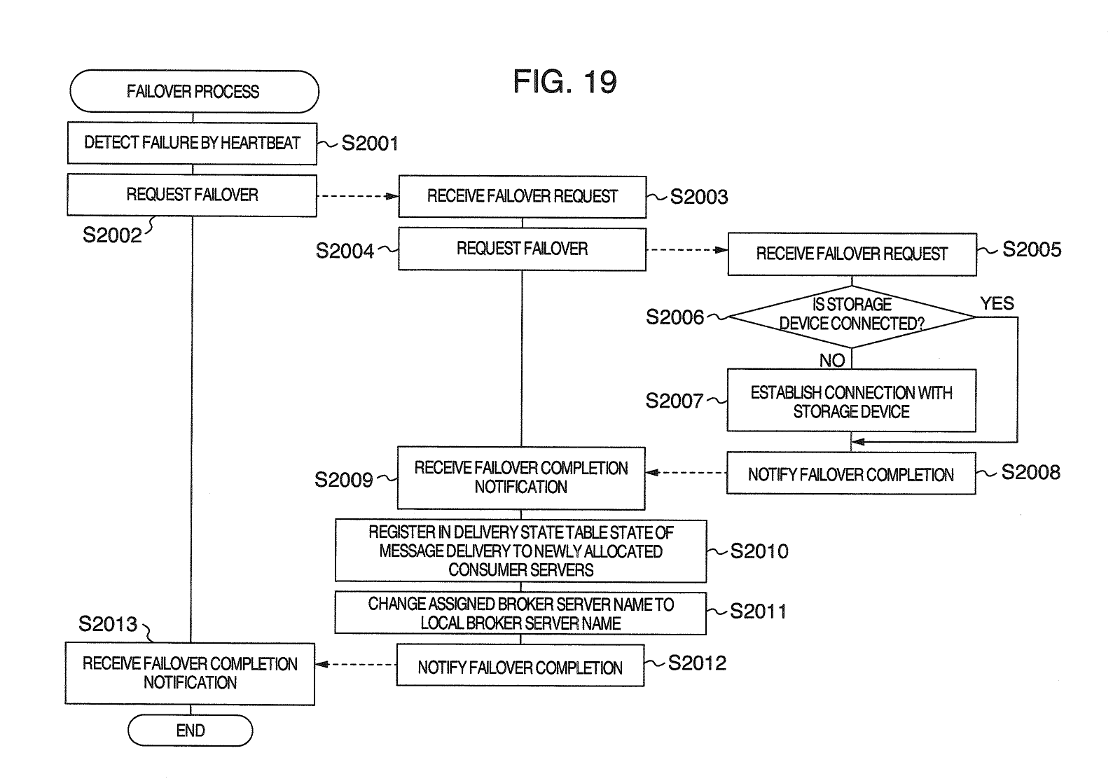

FIG. 19 is a flow chart showing a sequence of steps in a failover process performed when one of the broker servers fails. In this embodiment, in the event that one of the broker servers fails, a failover is initiated with the other broker server taking over the message delivery process from the first. There is a difference in the failover process between a failure of the broker server 100 or normal delivery process broker server and a failure of the broker server 200 or slow consumer server-dedicated broker server. The difference derives from whether the broker server is connected with the storage device 105.

During normal process the delivery control switching units 114 of the broker serve 100 and the broker server 200 are checking each other's heartbeat to see whether the other broker server is running normally. When the switching unit 114 detects an interruption or loss of heartbeat, and therefore a failure, of the broker server 200, the failover process is initiated (S2001).

The delivery control switching unit 114 issues a failover request to the delivery processing unit 113 (S2002). The delivery processing unit 113, on receiving the failover request (S2003), notifies the message management unit 112-1 of the failover request (S2004).

On receiving the failover request (S2005), the message management unit 112 checks whether this broker server is connected with the storage device 105. In this embodiment, the storage device 105 is not connected to the normal delivery process broker server 100 but to the slow consumer server-dedicated broker server 200. So, the result of decision made by the message management unit 112-1 in the event of a failure of the broker server 200 is in the negative (“no”) whereas in the event of a failure of the broker server 100, the result of decision made by the message management unit 112-2 is in the affirmative (“yes”) (S2006).

If the decision result at S2006 is “no”, the message management unit 112 establishes a connection between this broker server and the storage device 105 to make available for use in this broker server the messages held in the storage device 105 that have yet to be delivered to consumer servers and to persist the messages held in the message buffer 116 of this broker server (S2007). Then the message management unit 112 returns a failover completion notification to the delivery processing unit 113. If the decision result at S2006 is “yes”, the message management unit 112 simply returns the failover completion notification to the delivery processing unit 113 without executing the step S2007 (S2008).

Upon receiving of the failover completion notification (S2009), the delivery processing unit 113 newly adds to the delivery state table 640 the message delivery states of the consumer servers 500 covered by the failed broker server (S2010). The delivery processing unit 113 then changes the assigned broker server names 623 for these consumer servers in the delivery control table 620 to the server name of this broker server (S2011) and notifies the delivery control switching unit 114 of the failover completion (S2012). When the switching unit 114 receives the failover completion notification from the delivery processing unit 113, the failover process is exited (S2013).

While this embodiment employs two broker servers to construct a concurrently active dual system, it is possible to adopt an HA configuration made up of a main system and a standby system. In the HA-configured system, the message delivery may be performed only by the main broker server during a normal condition and, when some consumer servers changes to slow consumer servers, the standby broker server may be activated to function as a slow consumer server-dedicated broker server. In that case, since the slow consumer server-dedicated broker server is not engaged in the message delivery to normal consumer servers, a more stabilized performance of message delivery is assured for the normal consumer servers.

The number of broker servers used is not limited to two. Three or more broker servers may be used. In that case, at least one broker server needs only to be used as the normal delivery process broker server and as the slow consumer server-dedicated broker server. This configuration may also be combined with other load balancing technologies to further improve the message delivery performance.

In an initial state, this embodiment can allocate any desired consumer servers to the slow consumer server-dedicated broker server and to the normal delivery process broker server. But, consider an example situation where specifications of consumer servers are known and where it is possible to determine in advance which consumer servers are likely to become slow consumer servers. One possible approach in this case involves assigning beforehand the slow consumer server-dedicated broker server a task of delivering messages to those consumer servers that are likely to change to slow consumer servers and the normal delivery process broker server a task of delivering messages to other consumer servers and, during operating of the system, as in the embodiment described above, switching the process of message delivery to these consumer servers between the two broker servers according to the message delivery state. More specifically, based on the consumer servers' specifications, consumer servers with a lower performance than a predetermined level are allocated to the slow consumer server-dedicated broker server and those with a higher performance than the predetermined level are allocated to the normal delivery process broker server. Taking into account those factors affecting the processing performance of general computers, such as a processor capability (kind of processor), clock frequency and memory capacity of consumer servers, the performance of individual consumer servers can be determined. This method can be expected to reduce the number of delivery control switching process and therefore contribute to more stabilized message delivery performance of the broker servers.

Although in this embodiment each consumer server is assumed to receive all the messages destined for it that have been sent from the associated broker server, a publish/subscribe message delivery configuration may be adopted in which individual consumer servers register a kind (topic) of messages that they want delivered with broker servers in advance (subscribe to the topic) so that the broker servers deliver (publish) only the messages related to the registered topic to the associated consumer servers. In that case, the delivery control switching may be done for each topic.

With the above-described embodiment, the processes to deliver messages to the slow consumer servers and to persist those messages that remain to be delivered to the consumer servers are brought together and assigned only to a slow consumer server-dedicated broker server. This arrangement can alleviate adverse effects that an increased processing load from the message persistence process and the message resending process has on the process of message delivery to normal consumer servers. This arrangement also makes it easy to estimate the message delivery processing load in the broker server that is not engaged in sending messages to slow consumer servers, allowing lower cost computers to meet the performance requirements, which represents a cost-wise advantage.

Furthermore, since the above embodiment does not require all broker servers to have a storage device or the message persistence process to be performed redundantly by a plurality of broker servers, the capacity of the storage device can be put to effective use, minimizing the storage device configuration cost. Another advantage is that a reduced number of broker servers writing messages into the storage device can minimize the exclusive write control that needs to be performed when the storage device is shared by a plurality of broker servers. Still another advantage is that, if only one broker server writes into the storage device, the message writing can be done sequentially. A further advantage is that a performance degradation in the event of a consumer server turning slow can be minimized.

### Second Embodiment

The message delivery system 10 of the first embodiment is a concurrently active dual system, so that the consumer servers 500 covered by the slow consumer server-dedicated broker server 200 include both slow and normal consumer servers. In the second embodiment, the slow consumer server-dedicated broker server stands idle during normal condition and, only when there are slow consumer servers, performs message delivery to these slow consumer servers. That is, the broker server assigned to the message delivery to the normal consumer servers is separated from the broker server assigned to the message delivery to the slow consumer servers.

Further, while the first embodiment duplicates messages and holds them in two broker servers for enhanced reliability, the second embodiment does not always duplicate messages by sending message copies. Only when the message delivery control over consumer servers is switched between the broker servers, are batch of message copies sent to the other broker server so that each broker server can hold messages that they are assigned to deliver to their associated consumer servers.

A computer system in this embodiment has the same configuration of FIG. 1 as employed in the first embodiment. The following explanation mainly focuses on those parts of this embodiment that differ from the first embodiment, with the remaining parts that are similar to the corresponding parts of the first embodiment left out of explanation. In the drawings referred to in the following explanation, those portions identical with the corresponding ones of the first embodiment are assigned the same reference numbers as used in the first embodiment.

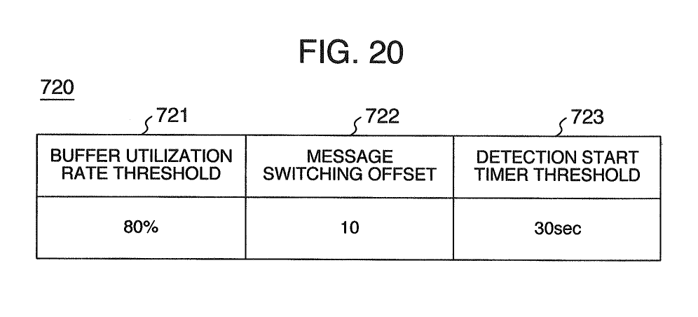

FIG. 20 is a conceptual diagram of a decision threshold table used in place of the decision threshold table 710 of the first embodiment.

The decision threshold table 720 includes a buffer utilization rate threshold 721, a message switching offset 722 and a detection start timer threshold 723.

The buffer utilization rate threshold 721 and the message switching offset 722 are used to detect slow or normal consumer servers and to determine a timing at which to start the detection process, as with the buffer utilization rate threshold 711 and the message switching offset 712.

The detection start timer threshold 723 is set with a threshold representing a time at which a normal consumer server detection process is triggered. In this embodiment, the normal consumer server detection process is executed at a time interval set in the detection start timer threshold 723.

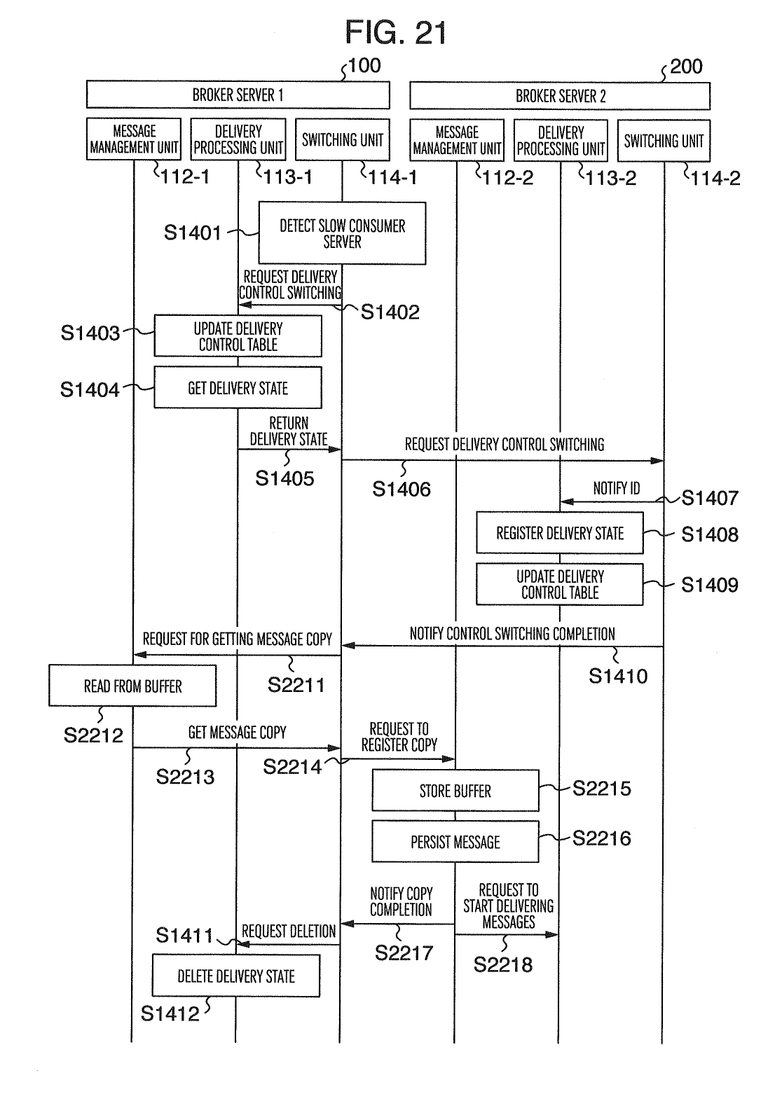

FIG. 21 is a sequence diagram showing a delivery control switching process to change the broker server tasked with sending messages to slow consumer servers, performed by a delivery control switching unit of the normal delivery process broker server in this embodiment.

A sequence of steps ranging from the detection of slow consumer servers to the notification of delivery control switching completion (S1401-S1410) is the same as that of the first embodiment. Since this second embodiment does not send message copies from the broker server 100 to the broker server 200 during the normal message delivery process, the message copies that need to be delivered to the slow consumer servers are sent from the broker server 100 to the broker server 200 after the switching of the message delivery control to the slow consumer server-dedicated broker server 200 is completed.

On receiving the delivery control switching completion notification, the delivery control switching unit 114-1 of the broker server 100 requests the message management unit 112-1 to get a copy of messages that need to be delivered to the slow consumer servers (S2211). The message management unit 112-1 reads from the message buffer 116-1 (S2212) those messages that have yet to be delivered to the slow consumer servers, which are to be reallocated to the other broker server, and takes them over to the switching unit 114-1 (S2213). The switching unit 114-1 sends the message copies received from the message management unit 112-1 to the message management unit 112-2 of the broker server 200 and requests it to register the message copies (S2214).

The message management unit 112-2 stores the received message copies in the message buffer 116-2 (S2215). If the message buffer 116-2 is likely to overflow, the message management unit 112-2 writes a part of the message copies into the storage device 105 for persisting message (S2216). Then the message management unit 112-2 notifies the switching unit 114-1 in the broker server 100 of the message copy registration completion (S2217). The message management unit 112-2 also requests the delivery processing unit 113-2 to initiate the message delivery to the slow consumer servers (S2218).

In the subsequent steps, the delivery processing unit 113-2 delivers messages to the slow consumer servers. If, after the start of the message delivery to the slow consumer servers, new messages from the producer server 400 arrive while the broker server 200 is delivering messages to the slow consumer servers, the batch of copies of the newly received messages may be sent from the broker server 100 to the broker server 200 at a predetermined timing, as when the broker server 200 has completed the delivery of the message copies it received. Alternatively, the new messages may be sent from the broker server 100 to the broker server 200 as they arrive at the broker server 100, as in the first embodiment.

Although this embodiment writes a part of the messages into the storage device 105 at step S2216 when there is a likelihood of a buffer overflow, it is also possible to write into the storage device 105 only the messages that failed to be written into the message buffer 116-2 or a part or all of the messages held in the message buffer 116-2 including those that have overflowed.

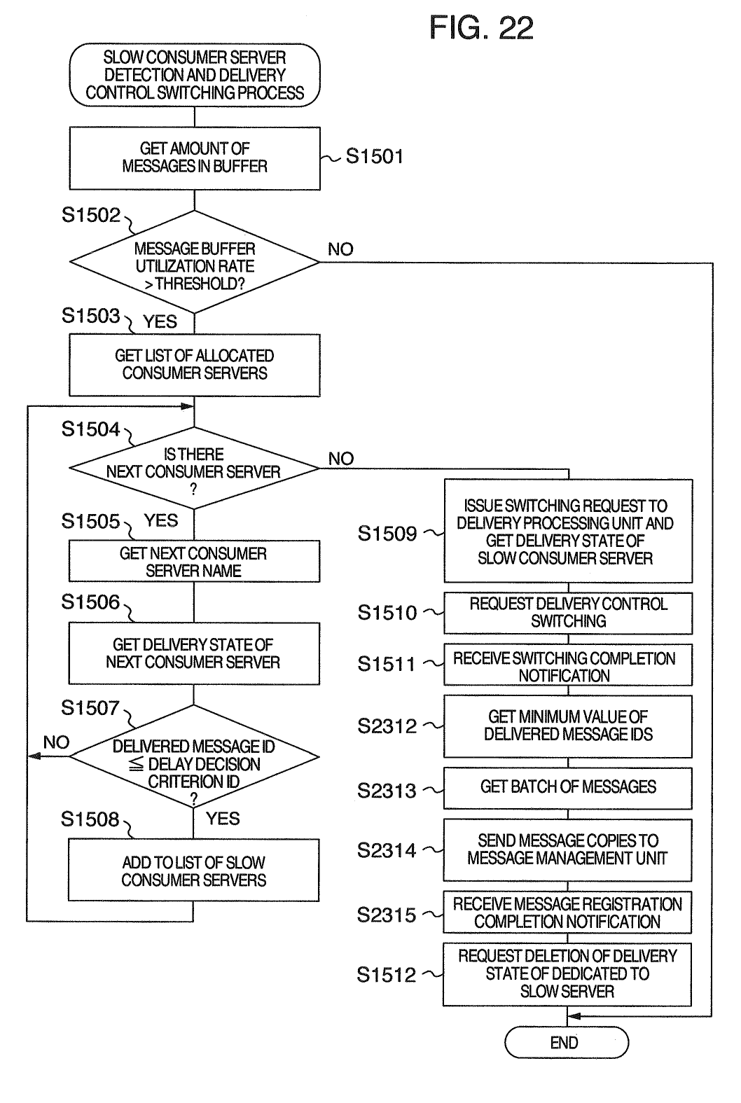

FIG. 22 is a flow chart showing a sequence of steps in the slow consumer server detection process and the delivery control switching process executed by the delivery control switching unit of the normal delivery process broker server in this embodiment. The slow consumer server detection process and the delivery control switching process in this embodiment are performed in the similar manner to that of the corresponding processes in the first embodiment shown in FIG. 14. This embodiment, however, differs from the first embodiment in that the batch of copies of the message are sent to the broker server 200 at steps added between the steps S1511 and S1512 of the first embodiment.

Having received a delivery control switching completion notification from the switching unit 114-2 of the broker server 200 at S1511, the switching unit 114-1 gets a minimum value of the delivered message ID 642 of all slow consumer servers in the delivery state table 640 that are to be reallocated to another broker server. The minimum value of the delivered message ID 642 may be obtained from the delivery state table 640, or from the broker server 200 when the switching unit 114-1 receives the switching completion notification (S2312). Next, the switching unit 114-1 gets at one time from the message management unit 112-1 a copy of messages ranging from the minimum delivered message ID 642 to the ID value held in the message ID counter 630 (S2313). The switching unit 114-1 sends the batch of the copies of the gotten message to the message management unit 112-2 of the broker server 200 (S2314) and waits for a notification of message registration completion from the message management unit 112-2 (S2315). On receiving the message registration completion notification from the message management unit 112-2, the switching unit 114-1 executes the message deletion process as in the first embodiment (S1512).

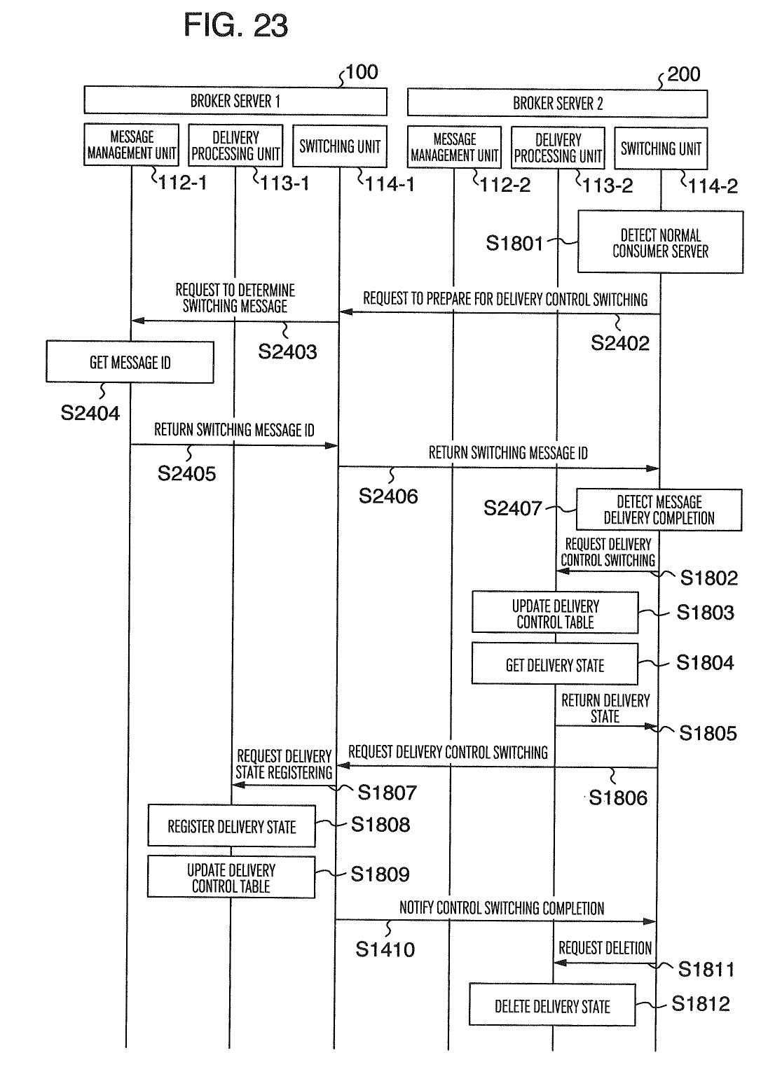

FIG. 23 is a sequence diagram showing a delivery control switching process to switch to the other broker server the control of message delivery to normal consumer servers.

In this embodiment, messages are not duplicated between the broker server 100 and the broker server 200, so that the messages held in the message buffers 116 of the two broker servers are not synchronized. So, when the broker server 200 issues a delivery control switching request, messages that have yet to be delivered to those consumer servers about to be reallocated to the other broker server may not remain in the message buffer 116-1 of the broker server 100. To deal with this problem, this embodiment determines the condition under which the message delivery control can be switched between the two broker servers, before the delivery control switching unit 114-2 issues a delivery control switching request. Only when this condition is met, can the delivery control switching be executed.

More specifically, on detecting a normal consumer server (S1801), the switching unit 114-2 in the broker server 200 requests the switching unit 114-1 in the broker server 100 to make a delivery control switching preparation for switch of the message delivery control over the detected normal consumer server to another broker server (S2402).

The delivery control switching unit 114-1 then requests the message management unit 112-1 to determine a message that triggers the switch of the message delivery control to another broker server (switching message). In this embodiment, a most recent message at the time of the delivery control switching preparation request (a message whose message ID is “one less than the value of the message ID counter 630”) is used as the switching message (S2403). When it receives the preparation request, the message management unit 112-1 gets an ID value from the message ID counter 630 to calculate an ID of the switching message (switching message ID) (S2404) and returns it to the switching unit 114-1. Then, the message management unit 112-1 retains in the message buffer 116-1 those messages with IDs later than the switching message ID until the delivery of these messages to the normal consumer server of interest is complete (S2405). The switching unit 114-1 returns the switching unit 114-2 in the broker server 200 of the switching message ID gotten from the message management unit 112-1 (S2406).

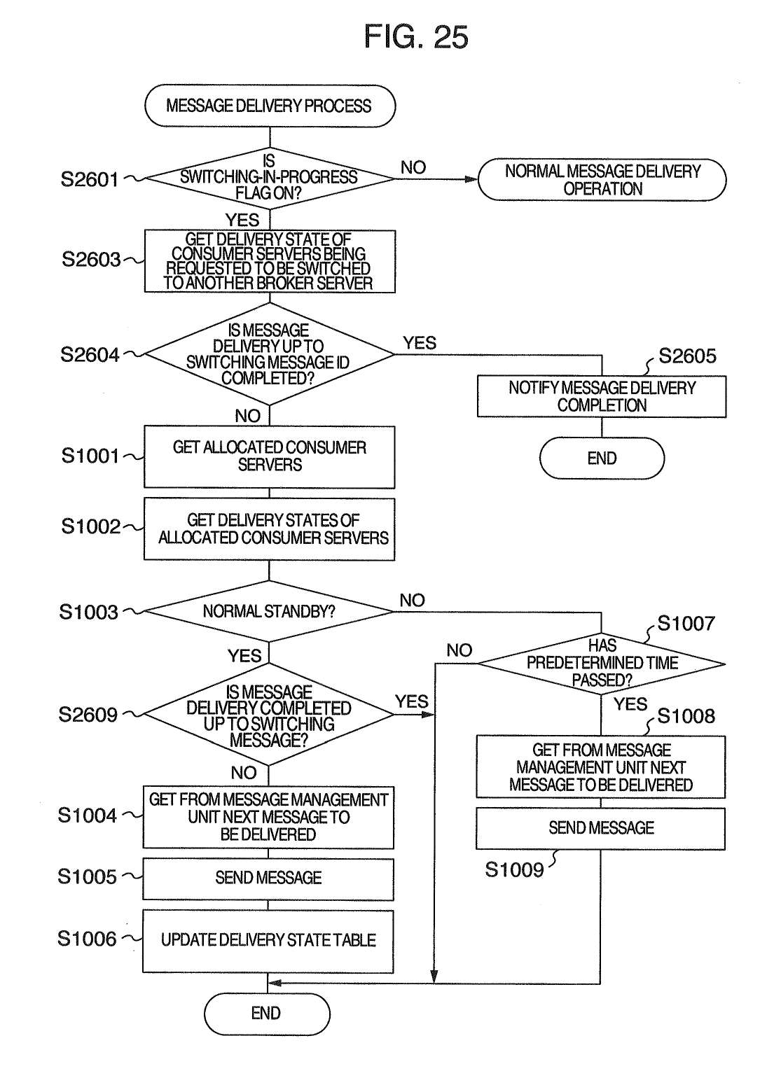

After the delivery control switching unit 114-2 has received the switching message ID, (the delivery processing unit 113-2) continues the message delivery to the consumer server which is about to be reallocated to the other broker server, until the delivery of a message with the switching message ID is finished. The message delivery process performed at this time will be described later by referring to FIG. 25.

When the message delivery process is completed up to the switching message ID received from the broker server 100, the delivery control switching unit 114-2 receives a delivery completion notification from the delivery processing unit 113-2 and at the same time initiates the delivery control switching process (S2407). Subsequent steps S2048-S2418 for the delivery control switching are executed, as in the first embodiment (S1802-S1812).

Since the delivery control switching in this embodiment is executed in two stages, the delivery state may change during a period of time from when the delivery control switching preparation is requested until the delivery control is actually switched. For example, in this period there is a possibility that the message buffer 116-1 of the broker server 100 may overflow, unable to retain the switching message, or that some of the normal consumer servers which are to be reallocated to the other broker server may turn slow again. In such cases, the delivery control switching process becomes difficult to continue. When these circumstances arise, this embodiment therefore cancels the delivery control switching process.

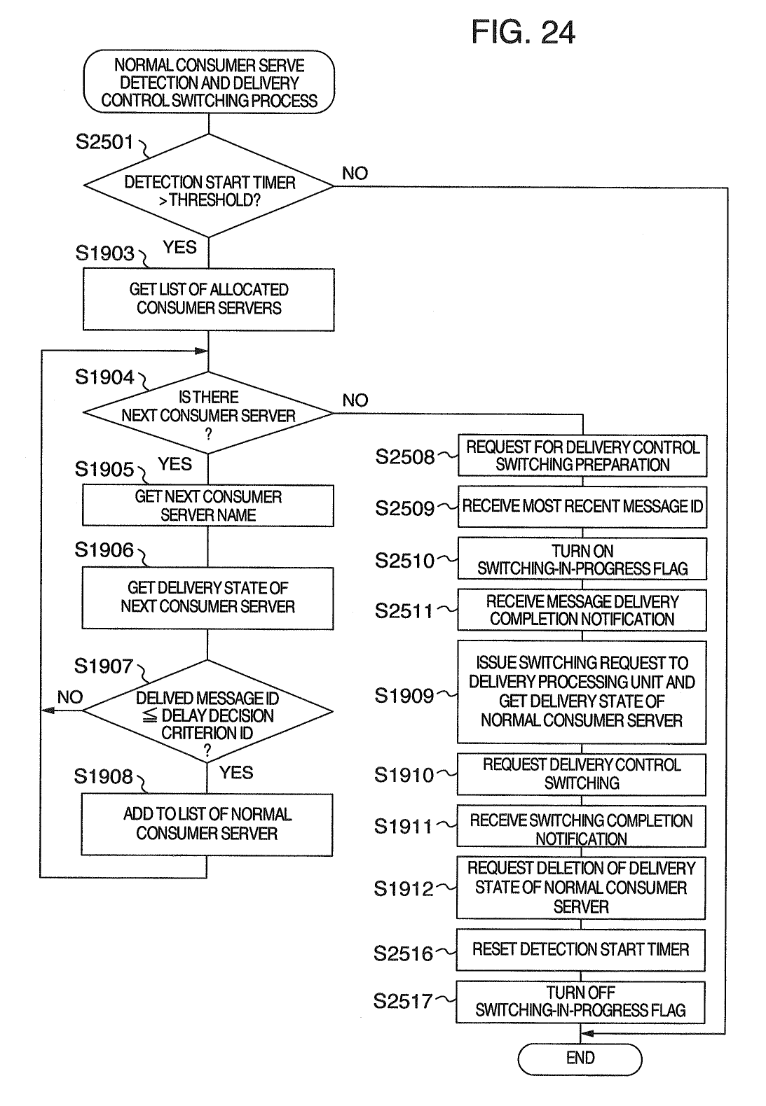

FIG. 24 is a flow chart showing a sequence of steps in the normal consumer server detection process and the delivery control switching process executed by the delivery control switching unit.

The delivery control switching unit 114-2 of the broker server 200 checks if a count value of the detection start timer is in excess of the value set in the detection start timer threshold 723 (S2501). If the count value of the detection start timer is greater than the value of the detection start timer threshold 723, the switching unit 114-2 performs the normal consumer server detection process (S1903-S1908).

If it is decided at S1904 that all the consumer servers covered by this broker server have undergone a check as to whether or not a consumer server of interest is a normal consumer server, the switching unit 114-2 sends a delivery control switching preparation request including a list of normal consumer servers to the switching unit 114-1 of the broker server 100 (S2508). When it receives the switching message ID from the switching unit 114-1 of the broker server 100 (S2509), the switching unit 114-2 turns “on” a flag indicating that the delivery control over these normal consumer servers is being switched over (switching-in-progress flag) and requests the delivery processing unit 113-2 to deliver messages of up to the switching message ID to the normal consumer servers that are about to be reallocated to the other broker server. The initial state of the switching-in-progress flag is “off”. When the switching-in-progress flag is “on”, the switching unit 114-2 does not initiate the normal consumer server detection process (S2510).

When the message delivery has been completed up to the switching message, the delivery control switching unit 114-2 receives a delivery completion notification from the delivery processing unit 113-2 (S2511). After receiving the delivery completion notification, the switching unit 114-2 switches the message delivery control over the normal broker servers to the other broker server (S1909-S1912).

With the delivery control switching completed, the delivery control switching unit 114-2 resets the detection start timer (S2516) and turns “off” the switching-in-progress flag to exit the switching process (S2517) before entering into the normal consumer server detection process again.

FIG. 25 is a flow chart showing a message delivery process executed by the delivery processing unit.

The delivery processing unit 113-2 refers to the switching-in-progress flag to see if the delivery control switching process is currently being executed. When the switching-in-progress flag is “off”, an normal message delivery process is performed in the same way as in the first embodiment shown in FIG. 9 (S2601).

When the switching-in-progress flag is “on”, the delivery processing unit 113-2 checks whether the message delivery is completed up to the switching message. More specifically, the delivery processing unit 113-2 gets from the delivery state table 640 the delivery states of all normal consumer servers that are requested to be reallocated to the other broker server (S2603) and checks all of these consumer servers to see if the delivered message ID 642 is equal to the switching message ID (S2604).

If the decision result at S2604 is “yes”, the delivery processing unit 113-2 notifies the delivery control switching unit 114-2 that the message delivery has been completed up to the switching message (S2605).

If the result of decision made at step S2604 is “no”, this means that there are some normal consumer servers for which the message delivery has not finished up to the switching message. So the message delivery process is executed. The message delivery process is performed in almost the same way as in the first embodiment shown in FIG. 10. It is noted, however, that when the switching-in-progress flag is “on”, there is no need to deliver messages following the switching message to the normal consumer servers currently in the process of being reallocated to the other broker server. Therefore, if step S1003 decides that a consumer server for which the messages are destined is in the “normal standby” state, the delivery processing unit 113-2 checks whether the message delivery to that consumer server is finished up to the switching message, i.e., whether the delivered message ID 642 is equal to the switching message ID (S2609). If it is found that the message delivery is completed up to the switching message, the delivery processing unit 113-2 does not perform the message delivery to the consumer server. If not, the delivery processing unit 113-2 executes steps S1004-S1006 to send messages.

In this embodiment, steps other than those explained in the above are executed in the same manner as in the first embodiment. Although the delivery control switching process for the normal consumer servers has been described to determine the switching message and have the broker server 200 perform the message delivery up to the switching message before executing the delivery control switching process, it is also possible, as in the delivery control switching process for slow consumer servers, to transfer the necessary messages from the broker server 200 to the broker server 100 upon detection of normal consumer servers before executing the delivery control switching process.

The second embodiment described above also is able to offer the similar advantages to those of the first embodiment. Further, since the second embodiment does not duplicate messages between the broker servers, as does the first embodiment, the contents of the message buffers in the two broker servers do not need to be the same. Therefore, the normal delivery process broker server can delete those messages that have been delivered to the consumer servers it covers immediately after their delivery, thereby putting the message buffers to efficient use. This in turn minimizes the memory capacity required by the system as a whole for the message delivery, allowing the system to be built at a lower cost. Further, if two or more of the normal delivery process broker servers are used, the message buffer areas provided one in each of the broker servers can be used effectively and therefore the processing load can be expected to be more evenly delivered.

Furthermore, in this embodiment since the batch of only copies of the necessary message need to be transferred between the broker servers when necessary, the data communication volume and the processing time required for transferring the message copies can be minimized.

### Third Embodiment

In the first embodiment, as the number of slow consumer servers increases, the load on the slow consumer server-dedicated broker server 200 also increases, giving rise to a possibility of the message delivery to slow consumer servers getting even more delayed. This is not likely to cause further problems for the slow consumer servers because their message delivery is already delayed. The increased load on the slow consumer server-dedicated broker server 200, however, will likely delay the message delivery to those slow consumer servers that are just going to return to normal.

To cope with the aforementioned problem, this embodiment adds another slow consumer server-dedicated broker server to the computer system of the first embodiment. As in the second embodiment, this embodiment gives explanations mainly about those portions that differ from the first embodiment. Explanations on the similar portions to the first embodiment will be omitted. In the drawings referenced by the following explanation, portions similar to the corresponding ones in the first embodiment will be assigned the same reference numbers as used in the drawings of the first embodiment.

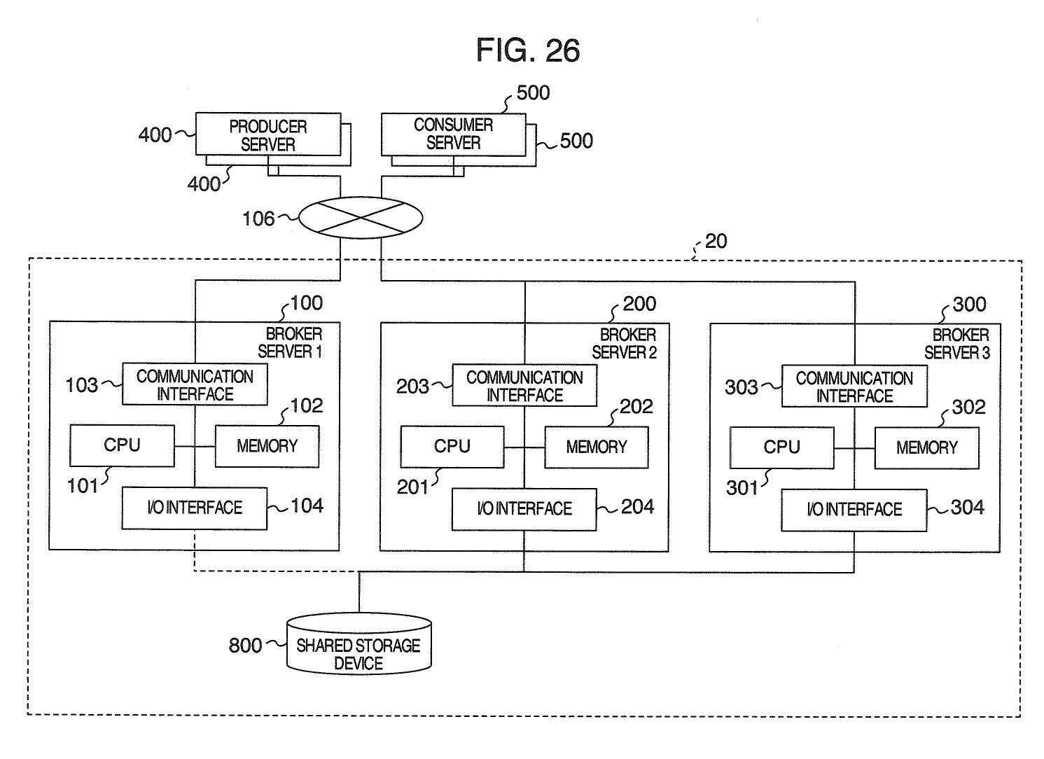

FIG. 26 is a simplified block diagram showing a hardware configuration of a computer system in the third embodiment.

The computer system of this embodiment is constructed in the similar manner to that of the first embodiment, except that another broker server 300 that functions as a slow consumer server-dedicated broker server is added to the broker servers making up a message delivery system 20 and that a shared storage device 800 is provided in place of the storage device 105 for shared use by the broker servers 200, 300.

The broker server 300 has a CPU 301, a memory 302, a communication interface 303 and an I/O interface 304, as do the broker servers 100 and 200. The broker server 300 also has a program module and tables, similar to those in the broker server 100 shown in FIG. 2. When it is necessary to distinguish the program module and tables from those of the broker servers 100 and 200, their reference numbers are attached with a subscript “−3”, like a message management unit 112-3 and a delivery processing unit 113-3.

In this embodiment, the broker server 300 does not perform the message delivery process during the normal state. When the number of slow consumer servers covered by the broker server 200 increases, thus increasing the load of the broker server 200, the broker server 300 takes over the message delivery control over a part of slow consumer servers from the broker server 200 to deliver the load of message delivery to the slow consumer servers between the two broker servers 200, 300.

Under normal condition, the shared storage device 800 is connected to both of the broker servers 200 and 300 for shared use. The shared storage device 800 is constructed to be able to be connected also to the broker server 100 in the event of a failure of the broker server 200 or 300 so that the broker server 100 can access data stored in the shared storage device 800. To prevent a possible access performance degradation caused by an exclusive access control on the storage device 800, this embodiment allows only the broker server 200 to write messages into the storage device and the broker server 300 to only read the messages from it.

In this embodiment, the message delivery process during normal condition and the delivery control switching between the broker server 100 and the broker server 200 are performed in the same way as in the first embodiment, unless otherwise specifically noted. So, only the delivery control switching process performed between the broker server 200 and the broker server 300 will be explained here. Now, the process of switching the delivery control over the consumer servers between the two broker servers in the third embodiment will be explained in the following. Not only is the consumer servers' delivery control switching between the broker server 100 and the broker server 200 the same as described in the first embodiment, but other processes are also similar to the corresponding ones in the first embodiment, unless otherwise noted.

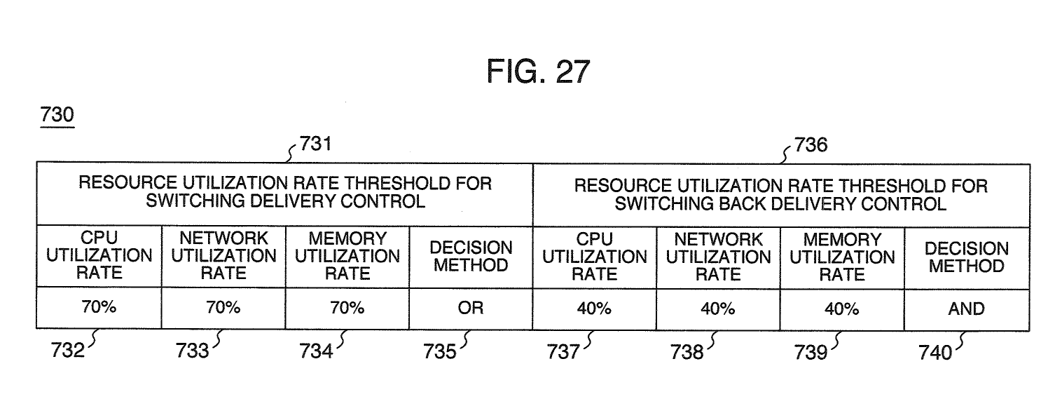

FIG. 27 is a conceptual diagram of a decision threshold table showing a set of thresholds used to decide whether or not to initiate a process of detecting consumer servers whose message delivery control needs to be switched over to or back from the other broker server. As for the delivery control switching between the broker server 100 and the broker server 200, the decision threshold table 710 explained in the first embodiment is used.

The decision threshold table 730 includes a resource utilization rate threshold for switching delivery control 731 and a resource utilization rate threshold for switching back delivery control 736. Both of the resource utilization rate thresholds, as with the resource utilization rate threshold 713 in the decision threshold table 710 of the first embodiment, have a CPU utilization rate 732, 737, a network utilization rate 733, 738, a memory utilization rate 734, 739 and a decision method 735, 740 as sub-items. Set values in the decision threshold table 730 can be changed through the interface managed by the broker servers, as in other tables.

The delivery control switching resource utilization rate threshold 731 is used in the broker server 200 as a criterion for initiating the process of detecting consumer servers whose delivery control needs to be switched over to the other broker server. When the resource utilization rate of the broker server 200 exceeds the threshold 731, the broker server 200 decides that its load has increased, determines a consumer server that needs to be switched to the other broker server and switches the message delivery control over the consumer server to the broker server 300.

The delivery control switching-back resource utilization rate threshold 736 is used in the broker server 300 as a criterion for initiating the process of detecting consumer servers whose delivery control needs to be switched back from the other broker server. When the resource utilization rate of the broker server 200 falls below the threshold 736, the broker server 300 decides that the broker server 200 has come out of the increased load condition and returns the message delivery control over the consumer server covered by the broker server 300 to the broker server 200.

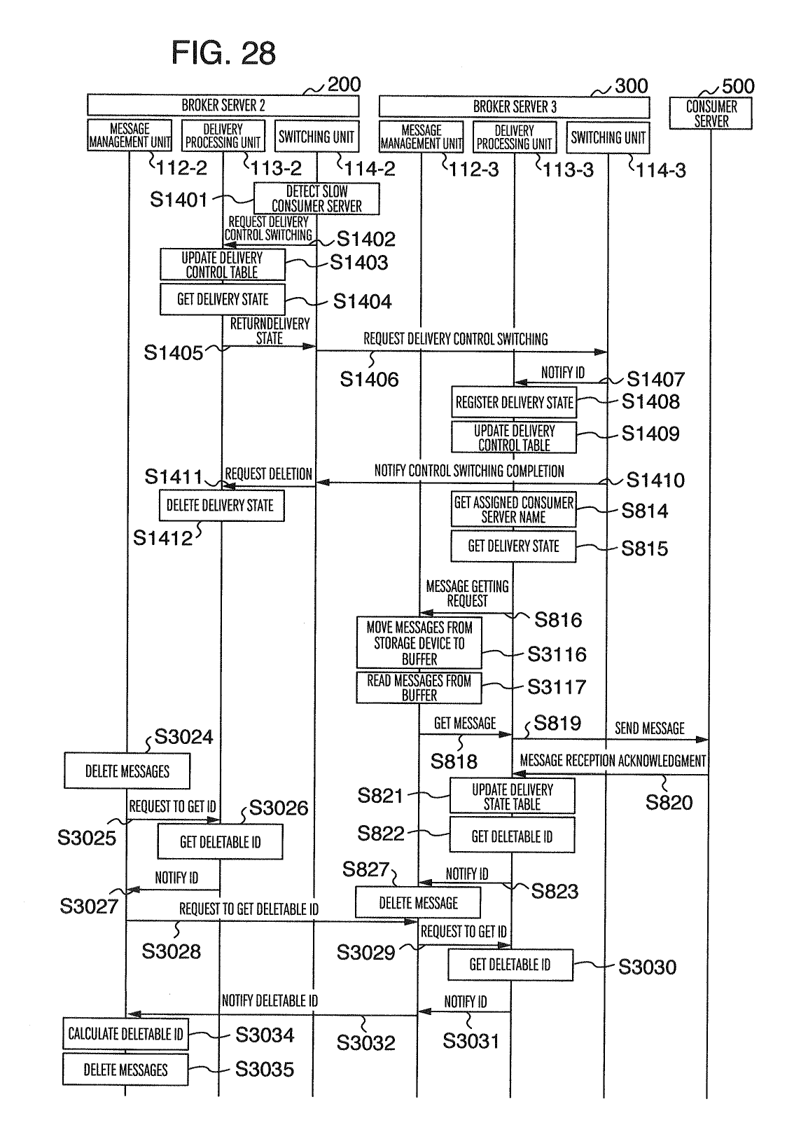

FIG. 28 is a sequence diagram showing a slow consumer server's delivery control switching process, a process of delivering messages to a slow consumer server, and a message deletion process, performed in this embodiment.

The switching of a message delivery control over a slow consumer server from the broker server 200 to the broker server 300 is triggered by an increase in the load of the broker server 200. In this process, the slow consumer servers under the delivery control of the broker server 200 are switched to the broker server 300 one at a time in order of message delivery delay, beginning with the consumer server that is most delayed in message delivery. Steps S1401-S1412 represents a process of switching the message delivery control over the slow consumer server from the broker server 200 to the broker server 300 after the slow consumer server has been detected. This switching process is similar to that of the first embodiment, except that the processing executed by the broker server 100 of the first embodiment in FIG. 13 is done by the broker server 200 and that the processing executed by the broker server 200 of the first embodiment is performed by the broker server 300.

A series of steps S814-S815, S3116-S3117 and S818-S827 represents an process of delivering messages to the slow consumer servers by the broker server 300. The steps S814-S815 and S818-S827 are the same as those with the corresponding reference numbers in the message delivery process (S814-S827) executed by the broker server 100 of the first embodiment shown in FIG. 7. The message delivery process performed by the broker server 300 is similar to that shown in FIG. 7, except that what is executing the message delivery is the broker server 300, that the message reading process (S817 in FIG. 7) is replaced with S3116 and S3117 described later and that the message deletion confirmation process (S824-S826 in FIG. 7) are not performed.

In this embodiment, the reallocation of the slow consumer servers to the broker server 300 begins with the one whose message delivery is most delayed. So, the message management unit 112-3 of the broker server 300 at step S3116 gets messages from the shared storage device 800 starting with the oldest message. In the message retrieval process, the message management unit 112-3 gets from the shared storage device 800 a certain amount of messages with their IDs equal to and later than the requested message ID and hold them in the message buffer 116-3 for a predetermined period of time. At step S3117 the message management unit 112-3 delivers these messages held in the message buffer 116-3 to the consumer servers as required. Since the messages are temporarily held in the message buffer 116-3, the repetitive reading from the storage device can be eliminated when performing a resending process or sending the same message to other consumer servers. Further, by retrieving messages with their IDs following the requested ID at the same time, the process efficiency can be expected to be improved by the advance reading of messages that would otherwise have to be read out later and by the sequential message reading from the storage device.

Steps S3024-S3035 represents a message deletion process performed by the broker server 200. In this embodiment since the messages in the shared storage device 800 are used by a plurality of broker servers, the message deletion process is required to confirm at least that the message that is going to be deleted are no longer necessary for all the broker servers using the shared storage device 800.

The message management unit 112-2 of the broker server 200 initiates the message deletion process at a predetermined timing. The message deletion process may be performed at a predetermined interval or initiated when a predetermined process starting criterion, such as a utilization of the storage device 800 or a load of the broker server 200, is exceeded (S3024).

Once the message deletion process has been started, the message management unit 112-2 requests a message ID of a deletable message from the delivery processing unit 113-2 (S3025). The delivery processing unit 113-2, upon receiving of this request, gets from the delivery state table 640 the minimum of the delivered message ID 642 as a deletable message ID (S3026) and gives it to the message management unit 112-2 (S3027). The message management unit 112-2, after receiving the deletable message ID, makes the similar request for the deletable message ID to the message management unit 112 of another broker server (S3028).

On receiving the request for the deletable message ID, the message management unit 112 of the other broker server requests for the deletable message ID from the delivery processing unit 113, as with the message management unit 112-2 of the broker server 200 (S3029). When it receives the deletable message ID from the delivery processing unit 113 (S3030, S3031), the message management unit 112 returns it to the message management unit 112-2 of the broker server 200 (S2032). Although FIG. 28 shows this processing only for the broker server 300, if there are other broker servers, the same processing is also executed for other broker servers.

The delivery processing unit 113-2 of the broker server 200, after receiving the deletable message IDs from all the broker servers in the message delivery system 20, determines the minimum of these IDs as a deletable message ID for the system as a whole (S3034). The message management unit 112-2 then deletes messages with IDs equal to and earlier than the deletable message ID determined at S3034 from the shared storage device 800 (S3035).

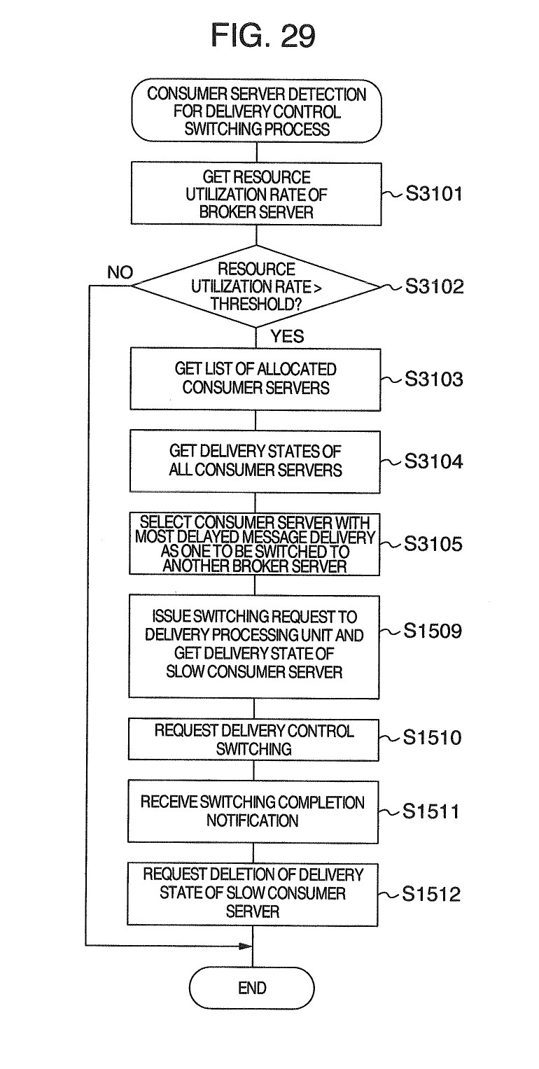

FIG. 29 is a flow chart showing a sequence of steps executed by a process of detecting consumer servers whose delivery control needs to be switched to the other broker server and a sequence of steps executed by a delivery control switching process.

The delivery control switching unit 114-2 gets the resource utilization rate of the broker server 200 (S3101) to decide whether the resource utilization rate is in excess of the delivery control switching resource utilization rate threshold 731 (S3102).

When the resource utilization rate is equal to or less than the threshold 731, the slow consumer server switching process is not performed. When the resource utilization rate exceeds the threshold 731, however, the delivery control switching unit 114-2 gets a list of consumer servers covered by this broker server from the delivery control table 620 (S3103) and also obtains the delivery states of all the consumer servers from the delivery state table 640 (S3104). Then, the switching unit 114-2 checks the delivered message IDs 642 of all the consumer servers covered and selects a consumer server with the smallest ID among the delivered message IDs 642 as the slow consumer server that needs to be switched to the other broker server (S3105).

Then, the delivery control switching unit 114-2 executes the process of switching the selected consumer server to the other broker server. This processing is performed in the similar manner to the delivery control switching process executed at S1509-S1512 by the broker server 100 in the first embodiment shown in FIG. 14. It is noted, in this case, that the processing done by the broker server 100 in the first embodiment is performed by the broker server 200 and that the processing done by the broker server 200 is executed by the broker server 300.

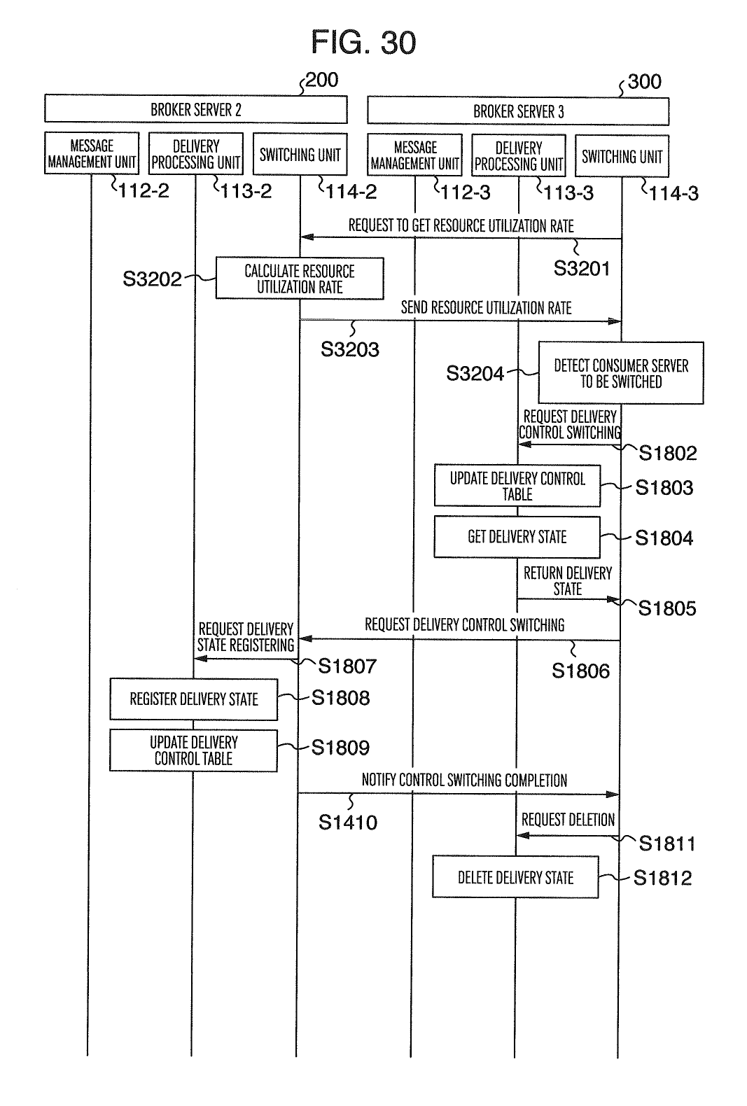

FIG. 30 is a sequence diagram showing a process of switching back the message delivery control from the broker server 300 to the broker server 200. In this embodiment, the switching-back process to switch a consumer server back from the broker server 300 to the broker server 200 is initiated when the broker server 200 has come out of the increased load condition. The switching-back process is performed on one consumer server at a time in the broker server 300 in order of message delivery progress, beginning with the consumer server that is most advanced in the message delivery.

The delivery control switching unit 114-3 of the broker server 300 requests a resource utilization rate from the switching unit 114-2 of the broker server 200 (S3201). In response to the request from the switching unit 114-3, the switching unit 114-2 of the broker server 200 determines the resource utilization rate of the broker server 200 (S3202) and returns it to the switching unit 114-3 of the broker server 300 (S3203).

The switching unit 114-3 of the broker server 300, based on the resource utilization rate received, checks whether the broker server 200 is ready to accept any returnable consumer server. If so, the switching unit 114-3 initiates a process of detecting a consumer server that can be switched back to the broker server 200 (S3204).

Steps subsequent to S3204 are executed in the same way as the delivery control switching process S1802-S1812 of the first embodiment shown in FIG. 17 that switch normal consumer servers from the broker server 200 to the broker server 100. In this case, it is noted that the processing done by the broker server 100 in the first embodiment is performed by the broker server 200 and the processing of the broker server 200 by the broker server 300, and that the consumer server to be switched back corresponds to the normal broker server in the first embodiment.

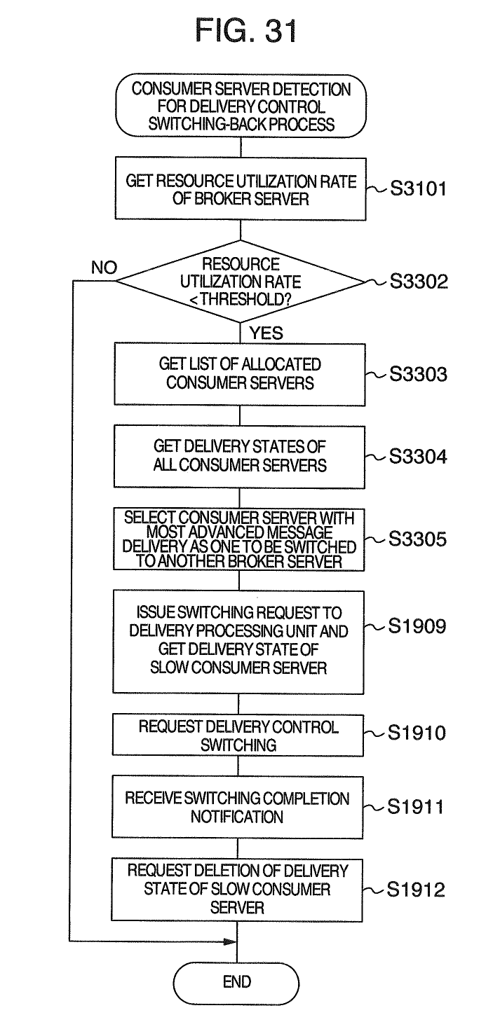

FIG. 31 is a flow chart showing a sequence of steps performed by the delivery control switching unit during the process of detecting consumer servers to be switched back to a former broker server and the delivery control switching process.

The delivery control switching unit 114-3 gets a resource utilization rate from the broker server 200 (S3101), compares the resource utilization rate obtained from the broker server 200 with a threshold set in the delivery control switching-back resource utilization rate threshold 736, and checks whether the resource utilization rate is lower than the threshold (S3302).

When the gotten resource utilization rate is in excess of the threshold set in the switching-back resource utilization rate threshold 736, the delivery control switching-back process is not initiated. When the resource utilization rate is lower than the threshold, the delivery control switching unit 114-3 gets a list of consumer servers covered by this broker server from the delivery control table 620 (S3303) and also obtains the delivery states of all these consumer servers from the delivery state table 640 (S3304). Then the switching unit 114-3 checks the delivered message IDs 642 of all the consumer servers covered and selects a consumer server with the largest of the delivered message IDs 642 as the consumer server to be switched back to the former broker server (S3305).

In the subsequent steps, the switching unit 114-3 performs the switching-back process on the selected consumer servers. This process is carried out in the same way as the delivery control switching process S1909-S1912 executed by the broker server 100 in the first embodiment shown in FIG. 18. In this case, it is noted that the processing done by the broker server 100 in the first embodiment is performed by the broker server 200 and the processing of the broker server 200 by the broker server 300 and that the consumer server to be switched back corresponds to the normal consumer server in the first embodiment. The third embodiment described above also can produce the similar advantageous effects to those in the first embodiment. Further, in the third embodiment since the message delivery to the slow consumer servers is performed by a plurality of slow consumer server-dedicated broker servers, the load of delivering messages to the slow consumer servers can be delivered among these dedicated broker servers.

The third embodiment adds another slow consumer server-dedicated broker server to the computer system of the first embodiment. It is also possible to add the second slow consumer server-dedicated broker server to the computer system of the second embodiment. While, in the third embodiment, two slow consumer server-dedicated broker servers are used, three or more of them may be used. Further, although the third embodiment has the second slow consumer server-dedicated broker server stand by without executing the message delivery process until the load of the first slow consumer server-dedicated broker server increases, the second dedicated broker server may be made to deliver messages while the first dedicated broker server is in the normal condition. For example, by dynamically changing the consumer server allocation category of the second dedicated broker server, the broker server 300 may be made to operate as a normal delivery process broker server while the load of the broker server 200 is small in order to evenly deliver the load of delivering messages to normal consumer servers. And when the load of the broker server 200 increases, the broker server 300 may be made to work as a slow consumer server-dedicated broker server.

In the embodiment described above, since the process of delivering messages to slow consumer servers and the process of persisting messages by storing them in the storage device are performed collectively by a particular broker server, the resource of the broker servers can be utilized efficiently even in the event of some consumer servers turning slow, assuring a stable message delivery to the consumer servers.

The present invention is, of course, not limited to the aforementioned embodiments and can accommodate a variety of changes and modifications without departing from the spirit thereof. For example, although in the above embodiments an ID of the last of the messages that have been delivered to each consumer server is used to determine the amount of messages that remain to be delivered to it, the number of messages remaining to be delivered to the consumer server may be directly managed. More precisely, this method involves incrementing the counter value when a message is delivered to the consumer server and, on receiving an acknowledgment, decrementing the counter. This allows the amount of accumulation messages to be managed directly.

While in the above embodiment messages delivered from a producer server are received by only one normal delivery process broker server which then transfers a copy of the messages to another broker server, it is also possible to have the producer server attach an identifier, that uniquely identifies each message, together with the order of message dispatch, to every message and to have all broker servers receive these messages.

### REFERENCE SIGNS LIST

100, 200, 300: Broker server
400: Producer server
500: Consumer server
105: Storage device
106: Network
800: Shared storage device
111: Data sending/receiving unit
112: Message management unit
113: Delivery processing unit
114: Delivery control switching unit
115: Management interface
116: Message buffer
610: Broker server table
620: Delivery control table
630: Message ID counter
640: Delivery state table
710, 720, 730: Decision threshold table

1. A message delivery method in a message delivery system, wherein the message delivery system has a first and a second computer and a storage device accessible by at least the second computer, receives messages from a sender and delivers them to a plurality of receiver computers through a network, the message delivery method comprising the steps of:
receiving the messages sent from the sender by the first computer;
delivering the messages to at least a part of the plurality of receiver computers and retrieving states of message delivery to at least the part of the receiver computers;
based on the message delivery states, checking whether there is, among at least the part of the receiver computers, any slow receiver computer for which the message delivery is delayed;
if it is found that there is a slow receiver computer, requesting a switch of a message delivery control over the slow receiver computer from the first computer to the second computer; and
causing the second computer to take over the message delivery control over the slow receiver computer and send the messages to the slow receiver computer.

2. The message delivery method according to claim 1,
wherein the message receiving step includes a step of transferring the messages to the second computer;
wherein the step of sending the messages to the slow receiver computer sends the messages transferred from the first computer in the message transferring step to the slow receiver computer.

3. The message delivery method according to claim 2 further comprising the steps of:
in the second computer, holding the messages transferred from the first computer in a buffer memory of the second computer; and
monitoring a utilization state of the buffer memory and, when a buffer memory utilization rate exceeds a predetermined threshold, storing at least a part of the messages in the storage device.

4. The message delivery method according to claim 1, further comprising the steps of:
in the second computer, retrieving a message delivery state of each of receiver computers under the message delivery control of the second computer;
based on the message delivery state got for each of the receiver computers under the message delivery control of the second computer, checking whether there is a normal receiver computer for which the message delivery is performed normally;
when there is a normal receiver computer, requesting a switch of the message delivery control over the normal receiver computer from the second computer to the first computer; and
causing the first computer to take over the message delivery control over the normal receiver computer and send the messages to the normal receiver computer.

5. The message delivery method according to claim 4, further comprising the steps of:
holding the messages in a buffer memory of the first computer; and
monitoring a utilization state of the buffer memory;
wherein, when a buffer memory utilization rate exceeds a predetermined threshold, processing following the step of checking whether there is a slow receiver computer is executed.

6. The message delivery method according to claim 5, wherein the step of checking whether there is a slow receiver computer uses as the message delivery state the number and volume of accumulation messages remaining to be delivered to the receiver computers, the state of a network between (the first computer) and the receiver computers or a response time from each of the receiver computers.

7. The message delivery method according to claim 4, wherein the step of checking whether there is a normal receiver computer determines as the normal receiver computer a receiver computer for which the volume of messages remaining to be delivered thereto is found to be less than a predetermined number, according to the message delivery state got for each of the receiver computers under the message delivery control of the second computer.

8. The message delivery method according to claim 7, further comprising the steps of:
in the second computer, retrieving a resource utilization rate of the second computer; and
when the resource utilization rate exceeds a predetermined threshold, processing following the step of checking whether there is a normal receiver computer is executed.

9. The message delivery method according to claim 7, wherein processing following the step of checking whether there is a normal receiver computer is executed at a predetermined time interval.

10. The message delivery method according to claim 4, wherein the message delivery system has a third computer, the message delivery method further comprising the steps of:
based on the message delivery state got for each of the receiver computers under the message delivery control of the second computer, checking whether, among the receiver computers under the message delivery control of the second computer, there is a slow second receiver computer for which the message delivery is delayed;
if it is found that there is the slow second receiver computer, requesting a switch of a message delivery control over the slow second receiver computer from the second computer to the third computer; and
causing the third computer to take over the message delivery control over the slow second receiver computer and send the messages to the slow second receiver computer.

11. A message delivery system to deliver messages to a plurality of receiver computers through a network, comprising:
a first computer and a second computer;
wherein the first computer has:
a memory having a first buffer to hold the messages received, first delivery control information specifying a computer in control of a message delivery to each of the plurality of receiver computers, and first delivery state information showing states of message delivery to first receiver computers that, in the first delivery control information, are placed under a message delivery control of this first computer;
a first message management means to receive the messages sent from a sender and hold them in the first buffer;
a first delivery means to deliver the messages to the first receiver computers and update the first delivery state information; and
a first switching means to check, based on the first delivery state information, whether among the first receiver computers there is a slow receiver computer for which the message delivery is delayed and, if it is found that there is the slow receiver computer, request a switch of a message delivery control over the slow receiver computer (to the second computer);
wherein the second computer has:
a memory having a second buffer to hold the messages received, second delivery control information specifying a computer in control of a message delivery to each of the plurality of receiver computers, and second delivery state information showing states of message delivery to second receiver computers that, in the second delivery control information, are placed under a message delivery control of this second computer;
a second message management means to receive the messages sent from the sender and hold them in the second buffer; and
a second delivery means to update, in response to the request from the first computer, the second delivery control information to include the slow receiver computer among the second receiver computers, deliver the messages to the second receiver computers and update the second delivery state information.

12. The message delivery system according to claim 11,
wherein the first message management means sends a copy of the messages sent from the sender to the second computer;
wherein the second message management means receives the message copies sent from the sender and stores them in the second buffer.

13. The message delivery system according to claim 12,
wherein the second message management means monitors a utilization state of the second buffer and, when a utilization rate of the second buffer exceeds a predetermined threshold, stores at least a part of the messages in a storage device.

14. The message delivery system according to claim 11,
wherein the second computer has a second switching means, the second switching means checking, based on the second delivery state information, whether there is a normal receiver computer for which the message delivery is performed normally and, if it is found that there is the normal receiver computer, requesting a switch of a message delivery control over the normal receiver computer (to the first computer);
wherein the first delivery means, in response to the request from the second computer, updates the first delivery control information to include the normal receiver computer among the first receiver computers.

15. The message delivery system according to claim 14,
wherein the first switching means monitors a utilization state of the first buffer and, when a utilization rate of the first buffer exceeds a predetermined threshold, checks whether there is the slow receiver computer, before requesting a switch of a message delivery control over the slow receiver computer (to the second computer).

16. The message delivery system according to claim 15,
wherein the first switching means uses the number and volume of accumulation messages remaining to be delivered to the receiver computers, the state of a network between (the first computer) and the receiver computers or a response time from each of the receiver computers in performing a check as to whether there is the slow receiver computer.

17. The message delivery system according to claim 14,
wherein the second switching means gets a resource utilization rate of the second computer and, when the resource utilization rate exceeds a predetermined threshold, checks whether there is the normal receiver computer, before requesting a switch of a message delivery control over the normal receiver computer (to the first computer).

18. The message delivery system according to claim 17,
wherein the second switching means, based on the second delivery state information, determines as the normal receiver computer a second receiver computer for which the volume of accumulation messages remaining to be delivered thereto is found to be less than a predetermined number.

19. The message delivery system according to claim 14, further comprising:
a third computer;
wherein the third computer has:
a memory having a third buffer to hold the messages received, third delivery control information specifying a computer in control of a message delivery to each of the plurality of receiver computers, and third delivery state information showing states of message delivery to third receiver computers that, in the third delivery control information, are placed under a message delivery control of this third computer;
a third message management means to receive the messages sent from the sender and hold them in the third buffer; and
a third delivery means to deliver the messages to the third receiver computer and update the third delivery state information;
wherein the second switching means, based on the second delivery state information, checks whether, among the second receiver computers, there is a slow second receiver computer for which the message delivery is delayed and, if it is found that there is the slow second receiver computer, request a switch of a message delivery control over the slow second receiver computer (to the third computer);
wherein the third delivery means updates, in response to the request from the second computer, the third delivery control information to include the slow second receiver computer among the third receiver computers.

20. A message delivery computer to deliver messages through a network to a plurality of receiver computers, comprising:
a memory having a buffer to hold the messages, computer information showing whether a computer of interest is assigned to deliver messages to those slow receiver computers among a plurality of receiver computers for which the message delivery is delayed, a message delivery control information specifying a computer in control of a message delivery to each of the plurality of receiver computers, and information on a state of message delivery to the receiver computers which, in the message delivery control information, are put under the message delivery control of this message delivery computer;
a message management means to receive the messages from outside and store them in the buffer;
a delivery processing means to deliver, according to the message delivery control information, the messages received by the message management means to those receiver computers under the message delivery control of this message delivery computer and updates the message delivery state information; and
a delivery control switching means which, when this message delivery computer is not assigned to deliver messages to the slow receiver computers,
detects the slow receiver computers from among the receiver computers under the message delivery control of this message delivery computer according to the message delivery state information and
requests a switch of a message delivery control over the detected slow receiver computers (to another message delivery computer) and
which, when this message delivery computer is assigned to deliver messages to the slow receiver computers,
detects normal receiver computers from among the receiver computers under the message delivery control of this message delivery computer according to the message delivery state information and
requests a switch of a message delivery control over the detected normal receiver computers (to another message delivery computer).
